(19) United States
(12) Patent Application Publication
(10) Pub. No.: US 2003/0110226 A1
(43) Pub. Date: Jun. 12, 2003

(54) E-mail sending/receiving method, e-mail system, and e-mail communication apparatus

(75) Inventors: Masakazu Inoue, Tokyo (JP); Yuri Kuroda, Tokyo (JP); Takeshi Fukuizumi, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/309,153

(22) Filed: Dec. 4, 2002

(30) Foreign Application Priority Data
Dec. 6, 2001 (JP) 2001-373145

(51) Int. Cl. G06F 15/16

(52) U.S. Cl. 709/206

(57) ABSTRACT

In the setting step of an e-mail sending/receiving method, a processing start condition representing a condition under which a receiving e-mail communication apparatus starts received mail processing is set by a sending e-mail communication apparatus. In the sending step, the set processing start condition is added to e-mail, and the e-mail is sent from the sending e-mail communication apparatus to the receiving e-mail communication apparatus. In the receiving step, the e-mail sent from the sending e-mail communication apparatus is received by the receiving e-mail communication apparatus. In the monitoring step, the status of the receiving e-mail communication apparatus or the status of another specific terminal apparatus is monitored. In the determining step, when the status of the receiving e-mail communication apparatus or the status of the specific terminal apparatus coincides with the processing start condition added to the received e-mail, the e-mail containing the processing start condition is processed by the receiving e-mail communication apparatus. An e-mail system and e-mail communication apparatus are also disclosed.

### BACKGROUND OF THE INVENTION

The present invention relates to an e-mail system and, more particularly, to an e-mail sending/receiving method, e-mail system, and e-mail communication apparatus in which a condition to start e-mail processing is designated by a sending side.

There has conventionally been proposed an e-mail system in which e-mail is sent from a sending e-mail communication apparatus to a receiving e-mail communication apparatus in advance and the recipient is caused to read the e-mail at time desired by the sender (see, e.g., Japanese Patent Laid-Open No. 2000-78308; to be referred to as reference 1 hereinafter).

In the conventional e-mail system, the sender sets, as time, a timing at which he/she wants the recipient to read mail. With only the time, satisfactory settings cannot be achieved for causing the receiving e-mail communication apparatus to open and display mail at a timing intended by the sender.

### SUMMARY OF THE INVENTION

The present invention has been made to overcome the conventional drawbacks, and has as its object to provide an e-mail sending/receiving method, e-mail system, and e-mail communication apparatus capable of causing a receiving e-mail communication apparatus to process received mail at a timing intended by the sender.

To achieve the above object, according to the present invention, there is provided an e-mail sending/receiving method comprising the setting step of setting, by a sending e-mail communication apparatus, a processing start condition representing a condition under which a receiving e-mail communication apparatus starts received mail processing, the sending step of adding the set processing start condition to e-mail and sending the e-mail from the sending e-mail communication apparatus to the receiving e-mail communication apparatus, the receiving step of receiving the e-mail sent from the sending e-mail communication apparatus by the receiving e-mail communication apparatus, the monitoring step of monitoring a status of the receiving e-mail communication apparatus or a status of another specific terminal apparatus, and the determining step of, when the status of the receiving e-mail communication apparatus or the status of the specific terminal apparatus coincides with the processing start condition added to the received e-mail, processing the e-mail containing the processing start condition by the receiving e-mail communication apparatus.

### BRIEF DESCRIPTION OF THE DRAWINGS

FIG. 1 is a block diagram showing the arrangement of a sending e-mail communication apparatus in an e-mail system according to the first embodiment of the present invention;

FIG. 2 is a block diagram showing the arrangement of a receiving e-mail communication apparatus in the e-mail system according to the first embodiment of the present invention;

FIG. 3 is a flow chart showing the operation of the sending e-mail communication apparatus;

FIG. 4 is a table showing the data structure of the accumulation unit of the sending e-mail communication apparatus;

FIG. 5 is a flow chart showing processing for setting position designation information in the sending e-mail communication apparatus;

FIG. 6 is a view showing a map displayed on the display unit of the sending e-mail communication apparatus;

FIG. 7 is a flow chart showing the operation of the receiving e-mail communication apparatus;

FIG. 8 is a flow chart showing mail reception processing of the receiving e-mail communication apparatus;

FIG. 9 is a table showing the data structure of the accumulation unit of the receiving e-mail communication apparatus;

FIG. 10 is a table showing an example of a matching table;

FIG. 11 is a flow chart showing received mail processing of the receiving e-mail communication apparatus;

FIG. 12 is a table showing another example of the matching table;

FIG. 13 is a table showing an action table displayed in setting action designation information;

FIG. 14 is a table showing another example of the matching table; and

FIG. 15 is a block diagram showing the arrangement of a position information server according to the 17th embodiment of the present invention.

### DESCRIPTION OF THE PREFERRED EMBODIMENTS

[First Embodiment]

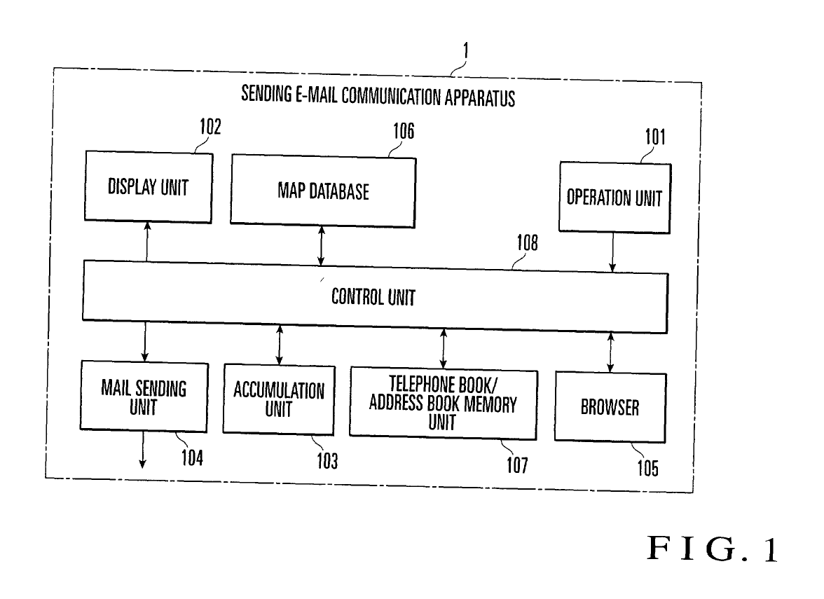

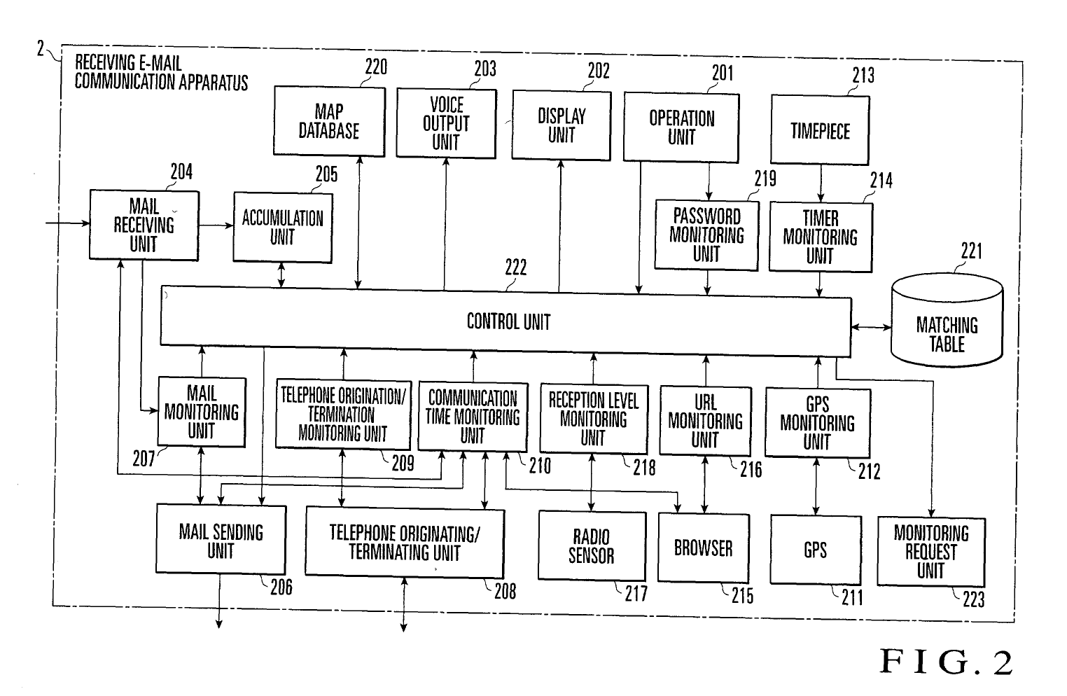

A preferred embodiment of the present invention will be described in detail below with reference to the accompanying drawings. FIG. 1 shows the arrangement of a sending e-mail communication apparatus 1 in an e-mail system according to the first embodiment of the present invention. FIG. 2 shows the arrangement of a receiving e-mail communication apparatus 2 in the e-mail system. The e-mail system is constituted by the sending e-mail communication apparatus 1, the receiving e-mail communication apparatus 2, and a communication network (not shown) which connects the sending and receiving e-mail communication apparatuses 1 and 2.

The sending e-mail communication apparatus 1 comprises an operation unit 101 made up of a plurality of key switches, a display unit 102 such as a liquid crystal panel which displays a window, an accumulation unit 103 in which e-mail to be sent is accumulated, a mail sending unit 104 which sends e-mail accumulated in the accumulation unit 103, a browser 105 which connects the sending e-mail communication apparatus 1 to the Internet and displays a Web page, a map database 106 which stores map information, a telephone book/address book memory unit 107 which stores data of a telephone book and e-mail address book, and a control unit 108 which controls the overall sending e-mail communication apparatus.

The operation unit 101 and control unit 108 constitute a setting means, and the mail sending unit 104 constitutes a sending means.

The receiving e-mail communication apparatus 2 comprises an operation unit 201, a display unit 202, a voice output unit 203 which converts e-mail data into an analog voice signal and outputs the voice signal from a loudspeaker, a mail receiving unit 204 which receives e-mail, an accumulation unit 205 in which e-mail received by the mail receiving unit 204 is accumulated, a mail sending unit 206 which sends e-mail, a mail monitoring unit 207 which always monitors mail communication processing by the mail receiving unit 204 and mail sending unit 206, a telephone originating/terminating unit 208 which performs telephone communication processing with another terminal apparatus, a telephone origination/termination monitoring unit 209 which always monitors telephone communication processing by the telephone originating/terminating unit 208, a communication time monitoring unit 210 which always monitors the communication time, a GPS (Global Positioning System) 211 which detects the apparatus position (latitude and longitude), a GPS monitoring unit 212 which always monitors the apparatus position, a timepiece 213 which counts the current date and time, a timer monitoring unit 214 which monitors the current date and time, a browser 215, a URL monitoring unit 216 which monitors access to the Internet by the apparatus 2, a radio sensor 217 which detects the reception level of radio waves from the base station, a reception level monitoring unit 218 which always monitors the reception level of radio waves from the base station, a password monitoring unit 219 which always monitors whether a password has been input from the operation unit 201, a map database 220, a matching table 221 which stores operation designation information that is added to e-mail and sent, a control unit 222 which controls the whole receiving e-mail communication apparatus, and a monitoring request unit 223 which requests a position information server (not shown) to monitor the apparatus 2 and another specific terminal apparatus.

The mail receiving unit 204 constitutes a receiving means. The mail monitoring unit 207, telephone origination/termination monitoring unit 209, communication time monitoring unit 210, GPS monitoring unit 212, timer monitoring unit 214, URL monitoring unit 216, reception level monitoring unit 218, and password monitoring unit 219 constitute a monitoring means. The control unit 222 constitutes a control means. In the first embodiment, e-mail to which a processing start condition is added is processed by the receiving e-mail communication apparatus when a processing start condition added to received e-mail and the status of the receiving e-mail communication apparatus coincide with each other. The “status of the receiving e-mail communication apparatus” means the operation of the receiving e-mail communication apparatus or the action of the recipient on the receiving e-mail communication apparatus.

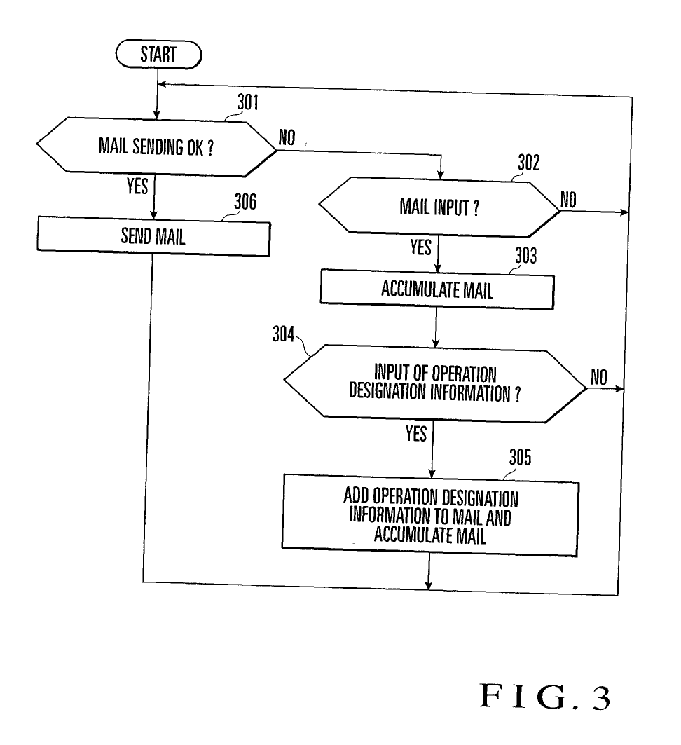

The operation of the e-mail system according to the first embodiment will be explained from the viewpoint of the operation of the sending e-mail communication apparatus 1. FIG. 3 shows the operation of the sending e-mail communication apparatus 1. If the sending e-mail communication apparatus 1 is powered on, the control unit 108 waits for operation by the apparatus user (to be referred to as a sender hereinafter) (step 301 in FIG. 3).

Using the operation unit 101, the sender inputs an e-mail document to be sent. If e-mail is input from the operation unit 101 (YES in step 302), the control unit 108 temporarily accumulates the input e-mail data in the accumulation unit 103 (step 303).

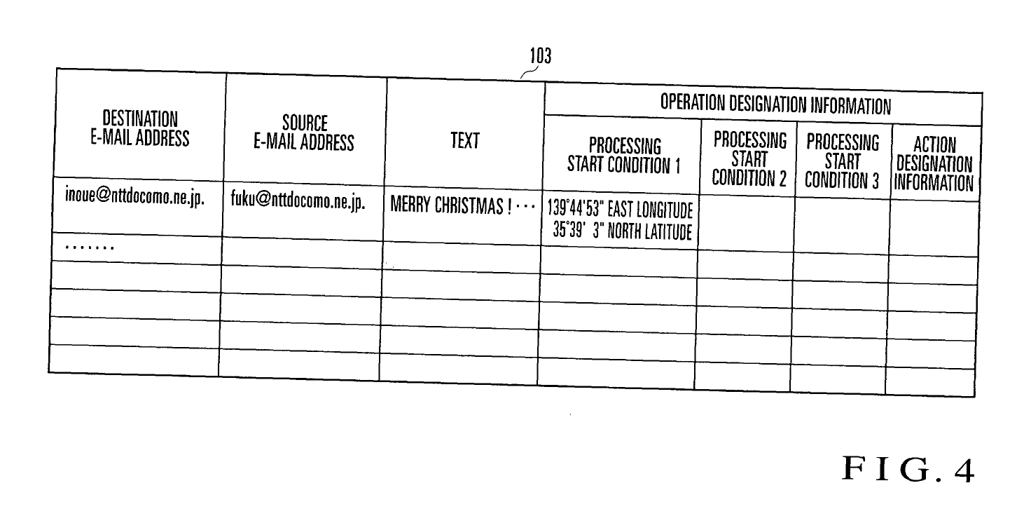

To designate the operation of the receiving e-mail communication apparatus 2 with respect to the mail, the sender inputs, using the operation unit 101, operation designation information which designates desired operation after inputting the mail document. If operation designation information is input from the operation unit 101 (YES in step 304), the control unit 108 adds the operation designation information to the accumulated e-mail data, and accumulates the resultant data in the accumulation unit 103 (step 305). The accumulation unit 103 has a data structure as shown in FIG. 4. The accumulation unit 103 stores a destination e-mail address, a source e-mail address (apparatus address), an e-mail text, and operation designation information added to the e-mail.

Operation designation information contains a processing start condition representing a condition to start processing of received mail by the receiving e-mail communication apparatus 2, action designation information which designates the processing contents of received mail, processing count designation information which designates the processing count of received mail, automatic update designation information which designates whether to automatically update received mail, and valid term designation information which designates the valid term of received mail. The sender need not set action designation information, processing count designation information, automatic update designation information, and valid term designation information, but must set the processing start condition.

The processing start conditions include position designation information which starts processing of received mail when the receiving e-mail communication apparatus 2 arrives at a desired position, telephone communication designation information which starts processing of received mail when specific telephone communication processing is done between a terminal apparatus having a specific telephone number and the receiving e-mail communication apparatus 2, mail communication designation information which starts processing of received mail when specific mail communication processing is done between a terminal apparatus having a specific e-mail address and the receiving e-mail communication apparatus 2, resource designation information which starts processing of received mail when the receiving e-mail communication apparatus 2 accesses a specific resource on the Internet, communication time designation information which starts processing of received mail when the communication time of the receiving e-mail communication apparatus 2 exceeds a predetermined value, reception level designation information which starts processing of received mail when the reception level of radio waves from the base station by the receiving e-mail communication apparatus 2 is higher or lower than a preset reception level threshold, password designation information which starts processing of received mail when the recipient inputs a specific password to the receiving e-mail communication apparatus 2, and date & time designation information which designates desired date and time.

In the first embodiment, position designation information is set as a processing start condition in order to start mail processing when the receiving e-mail communication apparatus 2 arrives at a desired position. To set the position designation information, the sender causes the sending e-mail communication apparatus 1 to display a map. That is, the control unit 108 displays a map on the display unit 102 on the basis of data of the map database 106 in accordance with sender operation. The sender designates a desired position on the map by using the operation unit 101.

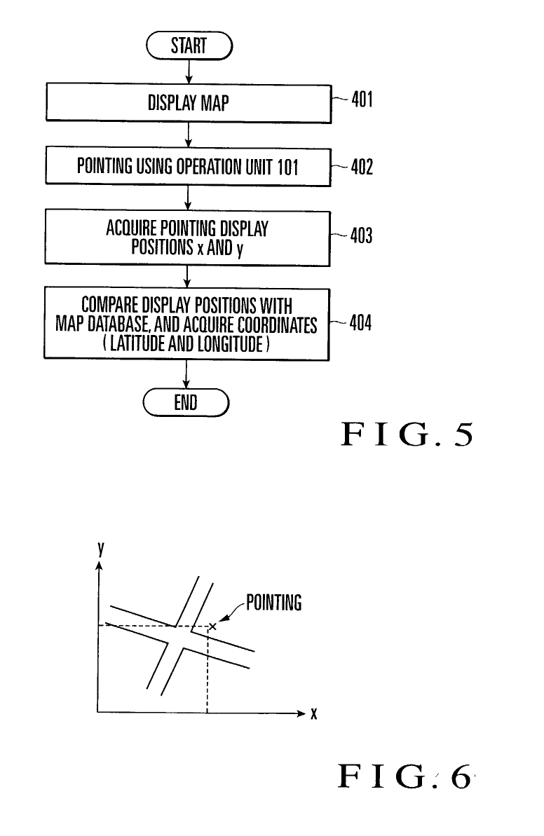

The control unit 108 obtains coordinate data (e.g., 139° 44′ 53″ east longitude and 35° 39′ 3″ north latitude) of the designated position by looking up the map database 106. The control unit 108 adds the obtained coordinate data as a processing start condition (position designation information) to e-mail data (step 305). This processing includes processing steps as shown in FIG. 5. The control unit 108 causes the display unit 102 to display a map as shown in FIG. 6 (step 401 in FIG. 5). In FIG. 6, x and y represent the ordinate and abscissa on the display window. The sender points a desired position on the displayed map by using the operation unit 101 (step 402). The control unit 108 obtains the pointed display positions x and y (step 403), and acquires coordinate data (latitude and longitude) by comparing the display positions x and y with the map database 106 (step 404). Note that coordinate data is acquired from the map database 106 in the first embodiment, but may be acquired by accessing a map data service site on the Internet.

If the sender ends input of all data and performs operation of starting mail sending (YES in step 301), the control unit 108 forwards, to the mail sending unit 104, e-mail data accumulated in the accumulation unit 103 and operation designation information added to it. The mail sending unit 104 connects the sending e-mail communication apparatus 1 to a communication network (not shown), and sends the e-mail data and operation designation information forwarded from the control unit 108 to the receiving e-mail communication apparatus 2 at the destination (step 306). After that, the operation of the sending e-mail communication apparatus 1 ends. As a method of adding operation designation information to e-mail, operation designation information is added as an attachment file to a normal mail text, and the mail with the attachment file is sent to the receiving e-mail communication apparatus. The file name of the attachment file is a special file name (e.g., dousasitei) representing operation designation information.

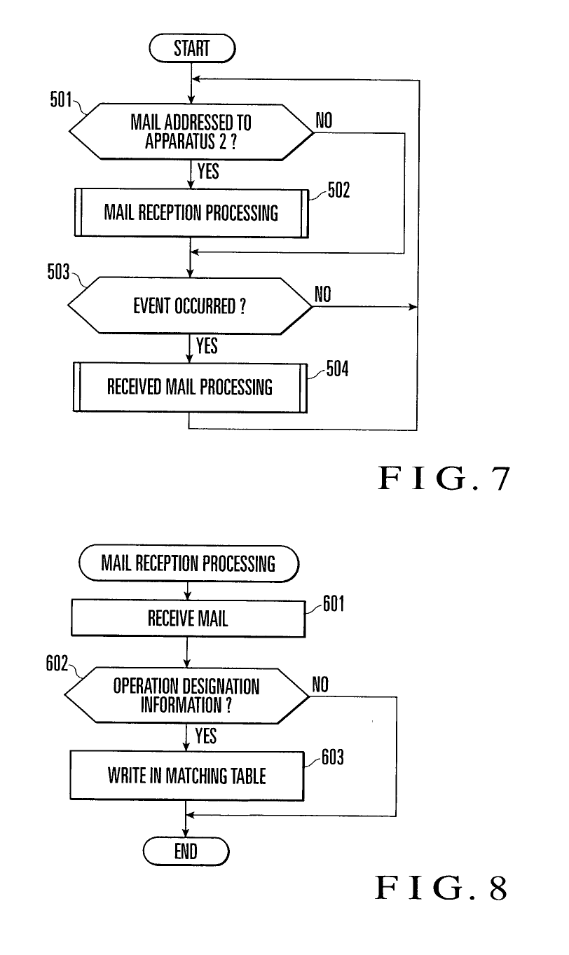

Next, the operation of the receiving e-mail communication apparatus 2 will be explained. FIG. 7 shows the operation of the receiving e-mail communication apparatus 2. If the receiving e-mail communication apparatus 2 is powered on, the control unit 222 instructs the mail receiving unit 204 to receive e-mail addressed to the apparatus 2. The mail receiving unit 204 establishes connection with the mail server of the communication network. If the mail server holds e-mail addressed to the apparatus 2 (YES in step 501 in FIG. 7), the mail receiving unit 204 executes mail reception processing (step 502). FIG. 8 shows mail reception processing of the receiving e-mail communication apparatus 2.

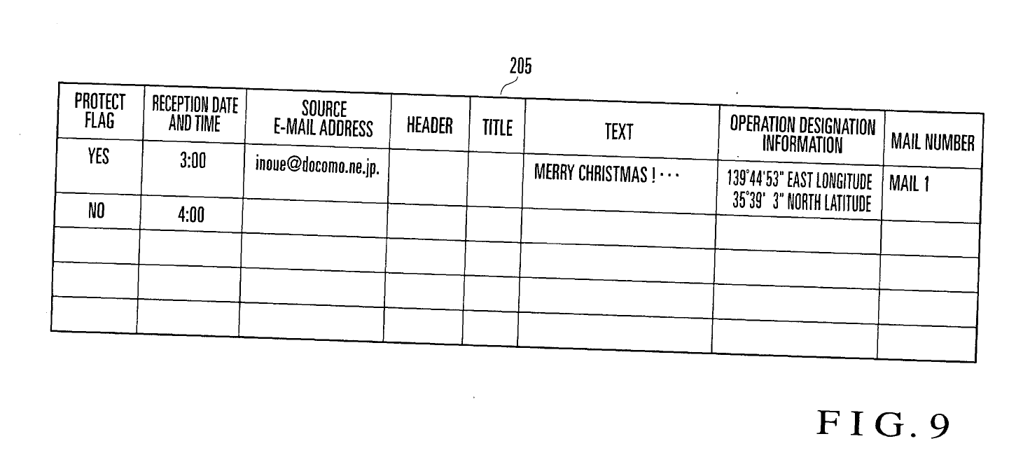

In mail reception processing, the mail receiving unit 204 receives e-mail addressed to the apparatus 2 from the mail server, and accumulates the received e-mail data in the accumulation unit 205 (step 601 in FIG. 8). If the e-mail has an attachment file representing operation designation information, the mail receiving unit 204 display-protects the mail text, and accumulates it in the accumulation unit 205. The accumulation unit 205 has a data structure as shown in FIG. 9. The accumulation unit 205 stores a protect flag representing whether the mail text is display-protected, an e-mail reception date and time, a source e-mail address, an e-mail header, an e-mail title, an e-mail text, operation designation information added to e-mail, and a mail number. The mail receiving unit 204 assigns each received mail a unique mail number. The control unit 222 checks whether operation designation information is added to received mail accumulated in the accumulation unit 205 (step 602).

If operation designation information is added to the received mail (YES in step 602), the control unit 222 makes the operation designation information match the mail number of the received mail, and writes them in the matching table 221 (step 603). Mail reception processing then ends.

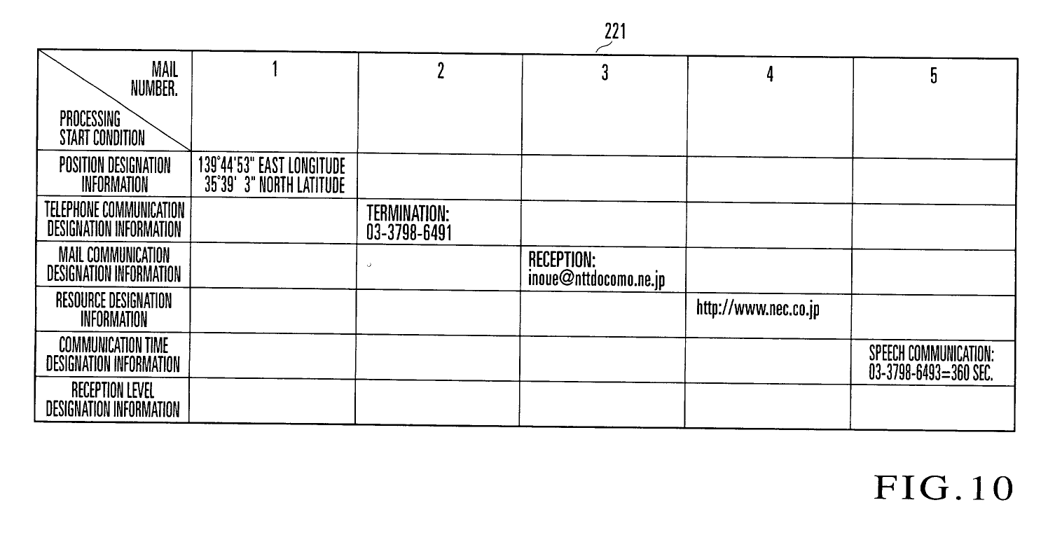

FIG. 10 shows an example of the matching table 221. As described above, the first embodiment sets position designation information as a processing start condition in operation designation information. If the received mail is assigned a mail number “1”, position designation information “139° 44′53″ east longitude and 35° 39′3″ north latitude” is stored in the matching table 221 together with the mail number “1”, as shown in FIG. 10.

If the operation designation information is added to the received mail, the user (to be referred to as a recipient hereinafter) of the receiving e-mail communication apparatus 2 cannot read the received mail contents unless the processing start condition in the operation designation information coincides with the status of the receiving e-mail communication apparatus 2. However, the recipient can refer to the mail header information and operation designation information on the display unit 202.

More specifically, if no operation designation information is added to the received mail (protect flag in FIG. 9 represents “NO”) upon reception of a received mail open instruction from the recipient, the control unit 222 opens and displays the mail text. If operation designation information is added to the received mail (protect flag represents “YES”), the control unit 222 causes the display unit 202 to display only the header information and operation designation information of the received mail. Since only the position designation information is set as operation designation information in the first embodiment, the position designation information is displayed using a map. The control unit 222 refers to the map database 220 on the basis of the position designation information “139° 44′ 53″ east longitude and 35° 39′ 3″ north latitude”. The control unit 222 displays the position at 139° 44′ 53″ east longitude and 35° 39′ 3″ north latitude on the map. This allows the recipient to confirm a detailed place designated by the position designation information.

If mail reception processing ends or no e-mail addressed to the apparatus 2 exists in step 501, the control unit 222 checks whether any event has occurred in the apparatus 2 (step 503 in FIG. 7). Events generated in the receiving e-mail communication apparatus 2 include a change in apparatus position, telephone origination/termination, mail sending/reception, access to the Internet, a change in communication time, a change in radio waves received from the base station (when the e-mail communication apparatus uses radio waves as a communication medium), input of a password by the recipient, and a change in date and time.

For example, the GPS 211 always detects the apparatus position, and outputs coordinate data representing the detected position to the GPS monitoring unit 212. When the current coordinate data acquired from the GPS 211 changes from the immediately preceding coordinate data, the GPS monitoring unit 212 determines that the apparatus position has changed, and sends a position change event notification containing the current coordinate data to the control unit 222.

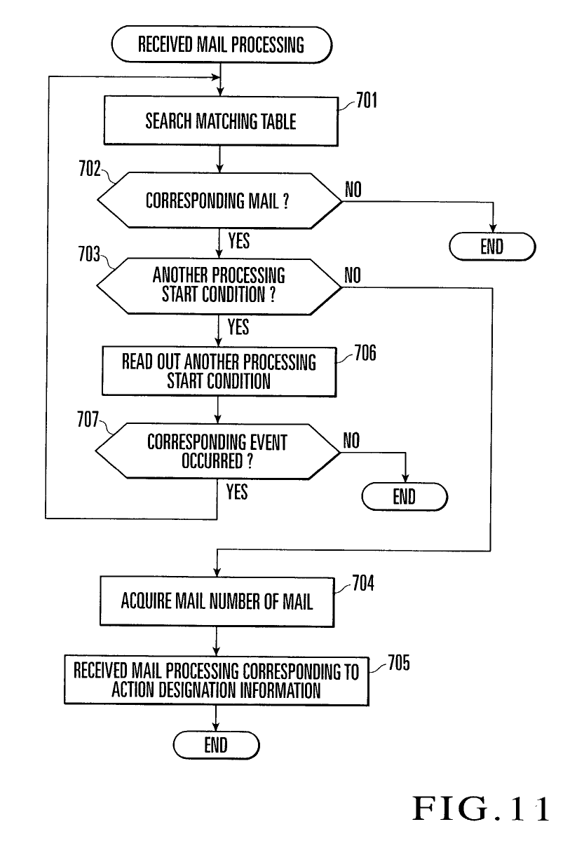

The control unit 222 which has received the position change event notification determines occurrence of the event (YES in step S503), and executes received mail processing (step 504). FIG. 11 shows received mail processing. In received mail processing, the control unit 222 stores the position change event notification. By looking up the matching table 221 based on the coordinate data contained in the position change event notification, the control unit 222 checks whether corresponding position designation information has been registered (step 701 in FIG. 11).

If no corresponding position designation information has been registered (NO in step 702), the control unit 222 ends received mail processing. If YES in step 702, the control unit 222 checks whether another processing start condition is added to the mail containing the position designation information (step 703).

For example, position designation information “139° 44′ 53″ east longitude and 35° 39′ 3″ north latitude” has been registered in the matching table 221. In this case, the determination is YES in step 702 when the recipient holding the receiving e-mail communication apparatus 2 arrives at the position at 139° 44′ 53″ east longitude and 35° 39′ 3″ north latitude. Since only the position designation information is set as a processing start condition in the first embodiment, the determination is NO in step 703, and the flow advances to step 704.

In step 704, the control unit 222 acquires the mail number of the mail from the matching table 221. The control unit 222 extracts mail data of the acquired number from the accumulation unit 205, and processes the extracted mail in accordance with action designation information in the operation designation information (step 705).

No action designation information is set in the first embodiment, and thus the control unit 222 processes the received mail in accordance with default action designation information set in advance by the recipient. For example, when “open and display” is set in advance as default action designation information, the control unit 222 causes the display unit 202 to display the received mail data extracted from the accumulation unit 205.

In this way, when the processing start condition in the operation designation information set by the sender coincides with the status of the receiving e-mail communication apparatus 2, e-mail sent by the sender is displayed on the display unit 202. This makes the recipient read the e-mail at a timing intended by the sender. The first embodiment can be applied to, e.g., a case wherein the sender and recipient are a pair of lovers. The sender designates a specific place, and makes the lover recipient read the mail when he/she arrives at the place.

[Second Embodiment]

The second embodiment of the present invention will be described. The arrangement and operation of an e-mail system in the second embodiment are the same as those in the first embodiment, and the same reference numerals as in FIGS. 1 to 11 denote the same parts. In the second embodiment, received mail processing starts when specific telephone communication processing is done between a terminal apparatus having a specific telephone number and a receiving e-mail communication apparatus 2 in FIG. 2. For this purpose, telephone communication designation information is set as a processing start condition.

The telephone communication designation information is made up of a telephone number, and telephone communication processing designation information which designates telephone communication processing. Mail processing starts upon termination from a terminal apparatus having a specific telephone number to the receiving e-mail communication apparatus 2. For this purpose, the sender inputs a specific telephone number “03-3798-6491” using an operation unit 101 of a sending e-mail communication apparatus 1 in FIG. 1, and sets “termination” as telephone communication processing designation information. As a result, telephone communication designation information is set as a processing start condition in operation designation information (step 305 in FIG. 3).

The remaining operation of the sending e-mail communication apparatus 1 is the same as that shown in FIG. 3. Note that the sender directly inputs a telephone number in the second embodiment. Alternatively, a desired telephone number may be selected from a telephone book stored in a telephone book/address book memory unit 107.

The whole operation of the receiving e-mail communication apparatus 2 is the same as that shown in FIG. 7. If received e-mail is assigned a mail number “2” in mail reception processing of FIG. 8, telephone communication designation information “termination: 03-3798-6491” is stored in a matching table 221 together with the mail number “2”, as shown in FIG. 10 (step 603).

If telephone communication processing (origination, termination, or disconnection) is done, a telephone originating/terminating unit 208 of the receiving e-mail communication apparatus 2 notifies a telephone origination/termination monitoring unit 209 of the contents of telephone communication processing and the telephone number of the communication partner. The telephone origination/termination monitoring unit 209 sends, to a control unit 222, a telephone communication event notification containing the notified telephone communication processing contents and telephone number.

The control unit 222 which has received the telephone communication event notification executes received mail processing (step 504). In received mail processing, the control unit 222 stores the telephone communication event notification. By looking up the matching table 221 based on the telephone communication processing contents and telephone number contained in the telephone communication event notification, the control unit 222 checks whether corresponding telephone communication designation information has been registered (step 701 in FIG. 11).

For example, telephone communication designation information “termination: 03-3798-6491” has been registered in the matching table 221. In this case, the determination is YES in step 702 when the receiving e-mail communication apparatus 2 receives an incoming signal from a terminal apparatus having the telephone number “03-3798-6491”.

The control unit 222 checks whether another processing start condition is added to the mail containing the telephone communication designation information (step 703). Since only the telephone communication designation information is set as a processing start condition, the control unit 222 acquires the mail number of the mail from the matching table 221 (step 704). Processing in step 705 is the same as that in the first embodiment.

The second embodiment can be applied to the following case. For example, the sender sets his/her telephone number as telephone communication designation information. When the sender calls the receiving e-mail communication apparatus 2, the processing start condition in operation designation information coincides with the status of the receiving e-mail communication apparatus 2. The sender can make the recipient read mail. Further, the sender can make the recipient read mail at the same time as speech conversation.

In the second embodiment, mail processing starts upon termination from a terminal apparatus having a specific telephone number to the receiving e-mail communication apparatus 2. To start mail processing upon origination from the receiving e-mail communication apparatus 2 to a terminal apparatus having a specific telephone number, “origination” is set as telephone communication processing designation information. To start mail processing upon disconnection of telephone communication between a terminal apparatus having a specific telephone number and the receiving e-mail communication apparatus 2, “disconnection” is set as telephone communication processing designation information.

[Third Embodiment]

The third embodiment of the present invention will be described. The arrangement and operation of an e-mail system in the third embodiment are the same as those in the first embodiment, and the same reference numerals as in FIGS. 1 to 11 denote the same parts. In the third embodiment, received mail processing starts when specific mail communication processing is done between a terminal apparatus having a specific e-mail address and a receiving e-mail communication apparatus 2 in FIG. 2. For this purpose, mail communication designation information is set as a processing start condition.

The mail communication designation information is made up of an e-mail address, and mail communication processing designation information which designates mail communication processing. Received mail processing starts when the receiving e-mail communication apparatus 2 receives e-mail from a terminal apparatus having a specific e-mail address. For this purpose, the sender inputs a specific mail address “inoue@nttdocomo.ne.jp” using an operation unit 101 of a sending e-mail communication apparatus 1 in FIG. 1, and sets “reception” as mail communication processing designation information. Hence, mail communication designation information is set as a processing start condition in operation designation information (step 305 in FIG. 3).

In the third embodiment, the sender directly inputs a mail address. Alternatively, a desired mail address may be selected from an address book stored in a telephone book/address book memory unit 107.

In mail reception processing of the receiving e-mail communication apparatus 2, if received e-mail is assigned a mail number “3”, mail communication designation information “reception: inoue@nttdocomo.ne.jp” is stored in a matching table 221 together with the mail number “3”, as shown in FIG. 10 (step 603 in FIG. 8).

If a mail receiving unit 204 and mail sending unit 206 of the receiving e-mail communication apparatus 2 perform mail communication processing (reception or sending), they notify a mail monitoring unit 207 of the contents of mail communication processing and the e-mail address of the communication partner. The mail monitoring unit 207 sends, to a control unit 222, a mail communication event notification containing the notified mail communication processing contents and mail address.

The control unit 222 which has received the mail communication event notification executes received mail processing (step 504 in FIG. 7). In received mail processing, the control unit 222 stores the mail communication event notification. By looking up the matching table 221 based on the mail communication processing contents and mail address contained in the mail communication event notification, the control unit 222 checks whether corresponding mail communication designation information has been registered (step 701 in FIG. 11).

For example, mail communication designation information “reception: inoue@nttdocomo.ne.jp” has been registered in the matching table 221. In this case, the determination is YES in step 702 when the mail receiving unit 204 receives mail from a terminal apparatus having the mail address “inoue@nttdocomo.ne.jp”.

The control unit 222 checks whether another processing start condition is added to the mail containing the mail communication designation information (step 703). Since only the mail communication designation information is set as a processing start condition, the control unit 222 acquires the mail number of the mail from the matching table 221 (step 704). Processing in step 705 is the same as that in the first embodiment.

The third embodiment can be applied to the following case. For example, the sender sets his/her mail address as mail communication designation information. When the sender sends the second mail to the receiving e-mail communication apparatus 2, the processing start condition in operation designation information coincides with the status of the receiving e-mail communication apparatus 2. The sender can make the recipient read the second mail at the same time as the first mail. This method can be adopted when a matter to be delivered is written in two mail messages.

In the third embodiment, mail processing starts when the receiving e-mail communication apparatus 2 receives e-mail from a terminal apparatus having a specific mail address. To start mail processing when the receiving e-mail communication apparatus 2 sends mail to a terminal apparatus having a specific telephone number, “sending” is set as mail communication processing designation information.

[Fourth Embodiment]

The fourth embodiment of the present invention will be described. The arrangement and operation of an e-mail system in the fourth embodiment are the same as those in the first embodiment, and the same reference numerals as in FIGS. 1 to 11 denote the same parts. In the fourth embodiment, received mail processing starts when a receiving e-mail communication apparatus 2 in FIG. 2 accesses the Internet. For this purpose, resource designation information is set as a processing start condition.

The resource designation information is formed from a URL (Uniform Resource Locators). To set resource designation information, the sender starts up a browser 105 of a sending e-mail communication apparatus 1 in FIG. 1, and designates a specific URL. In this case, a URL “http://www.nec.co.jp” is designated. Resource designation information is then set as a processing start condition in operation designation information (step 305 in FIG. 3).

In mail reception processing of the receiving e-mail communication apparatus 2, if received e-mail is assigned a mail number “4”, resource designation information “http://www.nec.co.jp” is stored in a matching table 221 together with the mail number “4”, as shown in FIG. 10 (step 603 in FIG. 8).

If a resource on the Internet is accessed in accordance with an instruction from the recipient, a browser 215 notifies a URL monitoring unit 216 of the resource URL. The URL monitoring unit 216 sends an Internet access event notification containing the notified URL to a control unit 222.

The control unit 222 which has received the Internet access event notification executes received mail processing (step 504 in FIG. 7). In received mail processing, the control unit 222 stores the Internet access event notification. By looking up the matching table 221 based on the URL contained in the Internet access event notification, the control unit 222 checks whether corresponding resource designation information has been registered (step 701 in FIG. 11).

For example, resource designation information “http://www.nec.co.jp” has been registered in the matching table 221. In this case, the determination is YES in step 702 when the recipient accesses the resource “http://www.nec.co.jp”.

The control unit 222 checks whether another processing start condition is added to the mail containing the resource designation information (step 703). Since only the resource designation information is set as a processing start condition, the control unit 222 acquires the mail number of the mail from the matching table 221 (step 704). Processing in step 705 is the same as that in the first embodiment.

The fourth embodiment can be applied to the following case. For example, the sender sets a specific Web page URL as resource designation information. When the recipient accesses the designated Web page, the processing start condition in operation designation information coincides with the status of the receiving e-mail communication apparatus 2. The sender can make the recipient read mail, and make the recipient read Web information and mail contents in association with each other.

[Fifth Embodiment]

The fifth embodiment of the present invention will be described. The arrangement and operation of an e-mail system in the fifth embodiment are the same as those in the first embodiment, and the same reference numerals as in FIGS. 1 to 11 denote the same parts. In the fifth embodiment, received mail processing starts when the telephone communication time, mail communication time, or Internet access communication time exceeds a predetermined value. For this purpose, communication time designation information is set as a processing start condition.

The communication time designation information is made up of the telephone number, e-mail address, or URL of a communication partner, and a communication time. The sender inputs, e.g., a specific telephone number “03-3798-6493” using an operation unit 101 of a sending e-mail communication apparatus 1 in FIG. 1, and sets a communication time “360 sec”. Only the communication time may be designated. In this manner, communication time designation information is set as a processing start condition in operation designation information (step 305 in FIG. 3).

In mail reception processing of a receiving e-mail communication apparatus 2, if received e-mail is assigned a mail number “5”, communication time designation information “speech communication: 03-3798-6493=360 sec ” is stored in a matching table 221 together with the mail number “5”, as shown in FIG. 10 (step 603 in FIG. 8).

A communication time monitoring unit 210 of the receiving e-mail communication apparatus 2 always monitors the telephone communication time of a telephone originating/terminating unit 208, the mail communication time of a mail receiving unit 204 or mail sending unit 206, or the Internet access communication time of a browser 215. The communication time monitoring unit 210 sends a communication time event notification containing the telephone number, e-mail address, or URL of the communication partner to a control unit 222 every predetermined time (e.g., 60 sec).

The control unit 222 which has received the communication time event notification executes received mail processing (step 504 in FIG. 7). In received mail processing, the control unit 222 stores the communication time access event notification. By looking up the matching table 221 based on the telephone number, e-mail address, or URL and the communication time, both of which are contained in the communication time event notification, the control unit 222 checks whether corresponding communication time designation information has been registered (step 701 in FIG. 11). This determination becomes YES if the communication time contained in the communication time event notification is equal to or longer than a communication time designated by communication time designation information.

For example, communication time designation information “speech communication: 03-3798-6493=360 sec” has been registered in the matching table 221. In this case, the determination is YES in step 702 when the telephone originating/terminating unit 208 performs telephone communication with a terminal apparatus having the telephone number “03-3798-6493” for 360 sec or more.

The control unit 222 checks whether another processing start condition is added to the mail containing the communication time designation information (step 703). Since only the communication time designation information is set as a processing start condition, the control unit 222 acquires the mail number of the mail from the matching table 221 (step 704). Processing in step 705 is the same as that in the first embodiment.

In the fifth embodiment, the sender sets a predetermined communication time as communication time designation information. When the recipient performs communication whose communication time exceeds the predetermined value, the processing start condition in operation designation information coincides with the status and date & time of the receiving e-mail communication apparatus 2. The sender can make the recipient read mail. This embodiment can display mail representing long-time communication when, e.g., the communication time of the recipient exceeds a predetermined value.

[Sixth Embodiment]

The sixth embodiment of the present invention will be described. The arrangement and operation of an e-mail system in the sixth embodiment are the same as those in the first embodiment, and the same reference numerals as in FIGS. 1 to 11 denote the same parts. In the sixth embodiment, received mail processing starts when the reception level of radio waves received from the base station by a receiving e-mail communication apparatus 2 in FIG. 2 is lower or higher than a preset reception level threshold. For this purpose, reception level designation information is set as a processing start condition.

The reception level designation information is information which designates the relationship in magnitude between a preset reception level threshold and a reception level at the start of received mail processing by the receiving e-mail communication apparatus 2. In the sixth embodiment, received mail processing starts if the reception level is lower than the reception level threshold. The sender sets reception level designation information “lower than the reception level threshold” using an operation unit 101 of a sending e-mail communication apparatus 1 in FIG. 1. Reception level designation information is set as a processing start condition in operation designation information (step 305 in FIG. 3).

In mail reception processing of the receiving e-mail communication apparatus 2, the reception level designation information is stored in a matching table 221 together with a mail number (step 603 in FIG. 8). A radio sensor 217 always detects the reception level of radio waves from the base station, and outputs the detected reception level information to a reception level monitoring unit 218. As the reception level measurement method, the field intensity may be directly measured, or the reception level may be measured from the magnitude of a received signal obtained upon reception of radio waves from the base station.

If the reception level detected by the radio sensor 217 changes by a predetermined amount or more, the reception level monitoring unit 218 sends a reception level change event notification containing the current reception level information to a control unit 222. The control unit 222 which has received the reception level change event notification executes received mail processing (step 504 in FIG. 7).

In received mail processing, the control unit 222 stores the reception level change event notification. By looking up the matching table 221 based on reception level information contained in the reception level change event notification, the control unit 222 checks whether corresponding reception level designation information has been registered (step 701 in FIG. 11). The determination is YES in step 702 if the current reception level is lower than the preset reception level threshold.

The control unit 222 checks whether another processing start condition is added to the mail containing the reception level designation information (step 703). Since only the reception level designation information is set as a processing start condition, the control unit 222 acquires the mail number of the mail from the matching table 221 (step 704). Processing in step 705 is the same as that in the first embodiment.

When the recipient moves to a place to which no radio wave from the base station reaches, and the reception level drops, the processing start condition in operation designation information set by the sender coincides with the status of the receiving e-mail communication apparatus 2. The sender can make the recipient read mail. This embodiment can display mail representing that the recipient is outside the service area of the base station when he/she moves apart from the service area.

[Seventh Embodiment]

The seventh embodiment of the present invention will be described. The arrangement and operation of an e-mail system in the seventh embodiment are the same as those in the first embodiment, and the same reference numerals as in FIGS. 1 to 11 denote the same parts. In the seventh embodiment, received mail processing starts when the recipient inputs a specific password to a receiving e-mail communication apparatus 2 in FIG. 2. For this purpose, password designation information is set as a processing start condition. That is, the sender sets a specific password as a processing start condition in operation designation information by using an operation unit 101 of a sending e-mail communication apparatus 1 in FIG. 1 (step 305 in FIG. 3).

In mail reception processing of the receiving e-mail communication apparatus 2, password designation information is stored in a matching table 221 together with a mail number (step 603). A password monitoring unit 219 of the receiving e-mail communication apparatus 2 always monitors whether a password has been input from an operation unit 201. If a password has been input, the password monitoring unit 219 sends a password input event notification containing the password to a control unit 222.

The control unit 222 which has received the password input event notification executes received mail processing (step 504 in FIG. 7). In received mail processing, the control unit 222 stores the password input event notification. By looking up the matching table 221 based on the password contained in the password input event notification, the control unit 222 checks whether corresponding password designation information has been registered (step 701 in FIG. 11). The determination is YES in step 702 if the input password coincides with a password designated by password designation information.

The control unit 222 checks whether another processing start condition is added to the mail containing the password designation information (step 703). Since only the password designation information is set as a processing start condition, the control unit 222 acquires the mail number of the mail from the matching table 221 (step 704). Processing in step 705 is the same as that in the first embodiment.

In the seventh embodiment, the sender sets a specific password as password designation information. When the recipient inputs the password, the processing start condition in operation designation information coincides with the status and date & time of the receiving e-mail communication apparatus 2. The sender can make the recipient read mail. According to this embodiment, for example, outgoing mail can be locked by a password, and only an authentic recipient who knows the password can be made to read the mail.

[Eighth Embodiment]

The eighth embodiment of the present invention will be described. Only one processing start condition is set in operation designation information in the first to seventh embodiments, but a plurality of processing start conditions may be set. The arrangement and operation of an e-mail system in the eighth embodiment are the same as those in the first embodiment, and the same reference numerals as in FIGS. 1 to 11 denote the same parts. In the eighth embodiment, received mail processing starts when a receiving e-mail communication apparatus 2 in FIG. 2 arrives at a desired position and specific telephone communication processing is done between a terminal apparatus having a specific telephone number and the receiving e-mail communication apparatus 2. For this purpose, position designation information and telephone communication designation information are set as processing start conditions.

The sender sets position designation information by the same procedures as those in the first embodiment, and sets telephone communication designation information by the same procedures as those in the second embodiment. The sender sets, using an operation unit 101, an AND code by which the two pieces of information are combined by AND operation. The resultant information obtained by combining the position designation information and telephone communication designation information by the AND code is set as a processing start condition in operation designation information (step 305 in FIG. 3). In this case, position designation information “139° 44′ 53″ east longitude and 35° 39′ 3″ north latitude” and telephone communication designation information “termination: 03-3798-6491” are set.

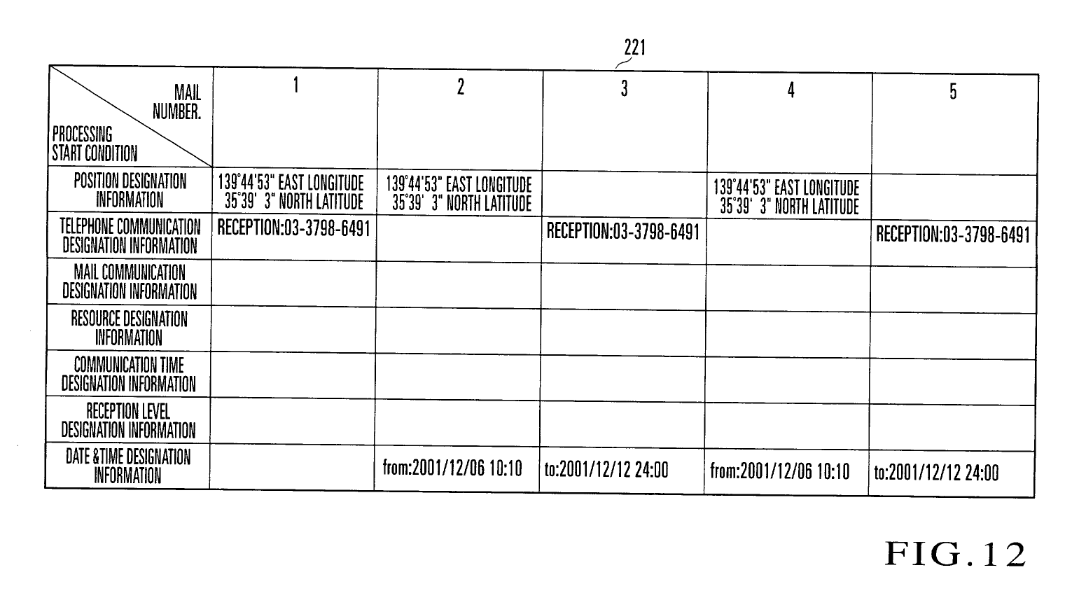

If received e-mail is assigned a mail number “1” in mail reception processing of the receiving e-mail communication apparatus 2, the position designation information “139° 44′53″ east longitude and 35° 39′ 3″ north latitude” and the telephone communication designation information “termination: 03-3798-6491” are stored in a matching table 221 together with the mail number “1”, as shown in FIG. 12 (step 603).

A control unit 222 which has received a position change event notification executes received mail processing (step 504 in FIG. 7). In received mail processing, the control unit 222 stores the position change event notification. By looking up the matching table 221 based on coordinate data contained in the position change event notification, the control unit 222 checks whether corresponding position designation information has been registered (step 701 in FIG. 11).

If the recipient holding the receiving e-mail communication apparatus 2 arrives at the position at 139° 44′ 53″ east longitude and 35° 39′ 3″ north latitude, the determination is YES in step 702. Subsequently, the control unit 222 checks whether another processing start condition is added to the mail containing the position designation information (step 703). In the eighth embodiment, telephone communication designation information is set in addition to the position designation information as processing start conditions. The determination is YES in step 703, and the flow shifts to step 706.

In step 706, the control unit 222 acquires another processing start condition added to the mail from the matching table 221. The control unit 222 checks whether an event corresponding to the acquired processing start condition in operation designation information has occurred (step 707). In this case, another processing start condition is telephone communication designation information, and the control unit 222 checks a telephone communication event notification from a telephone origination/termination monitoring unit 209.

If no telephone communication event notification is generated (NO in step 707), the control unit 222 ends received mail processing. If YES in step 707, the control unit 222 stores the telephone communication event notification. By looking up the matching table 221 on the basis of the coordinate data contained in the previously stored position change event notification and the telephone communication processing contents and telephone number contained in the telephone communication event notification, the control unit 222 checks whether corresponding position designation information and telephone communication designation information have been registered (steps 701 and 702).

In this embodiment, the determination is YES in step 702 if the recipient holding the receiving e-mail communication apparatus 2 arrives at the position at 139° 44′ 53″ east longitude and 35° 39′ 3″ north latitude and the receiving e-mail communication apparatus 2 receives an incoming signal from a terminal apparatus having the telephone number “03-3798-6491”.

The control unit 222 then checks whether still another processing start condition is added to the mail (step 703). Since the position designation information and telephone communication designation information have already been read out, the determination is NO in step 703, and the flow advances to step 704. Processes in steps 704 and 705 are the same as those in the first embodiment. In the eighth embodiment, a telephone communication event notification is generated after a position change event notification. These notifications may be generated in reverse.

According to the eighth embodiment, for example, the sender sets a specific place as position designation information, and sets his/her telephone number as telephone communication designation information. If the sender calls the receiving e-mail communication apparatus 2 while the recipient is at the designated place, the processing start conditions in operation designation information coincide with the status of the receiving e-mail communication apparatus 2. The sender can make the recipient read mail. The eighth embodiment can be applied to, e.g., a case wherein the sender and recipient are a pair of lovers. The sender can express his/her intention at an expected place and a specific timing.

[Ninth Embodiment]

The ninth embodiment of the present invention will be described. The arrangement and operation of an e-mail system in the ninth embodiment are the same as those in the first embodiment, and the same reference numerals as in FIGS. 1 to 11 denote the same parts. In the ninth embodiment, position designation information and date & time designation information are set as processing start conditions in order to start received mail processing when a receiving e-mail communication apparatus 2 arrives at a desired position and the current date and time exceed a desired date and time.

The sender sets position designation information by the same procedures as those in the first embodiment, and sets date & time designation information using an operation unit 101. The sender sets, using the operation unit 101, an AND code by which the two pieces of information are combined by AND operation. The date & time designation information can set various pieces of information: “from” representing a designated range after a specific date and time, “just” designating only a specific date and time, “before” representing a designated range before a specific date and time, “to” representing a designated range up to a specific date and time, and “for” representing a designated range from a given date and time to another date and time.

The resultant information obtained by combining the position designation information and date & time designation information by the AND code is set as a processing start condition in operation designation information (step 305 in FIG. 3). In this case, position designation information “139° 44′ 53″ east longitude and 35° 39′ 3″ north latitude” and date & time designation information “from: Dec. 6, 2001 10:10” are set.

If received e-mail is assigned a mail number “2” in mail reception processing of the receiving e-mail communication apparatus 2, the position designation information “139° 44′ 53″ east longitude and 35° 39′ 3″ north latitude” and the date & time designation information “from: Dec. 6, 2001 10:10” are stored in a matching table 221 together with the mail number “2”, as shown in FIG. 12 (step 603).

A timer monitoring unit 214 of the receiving e-mail communication apparatus 2 always monitors the current date and time counted by a timepiece 213, and sends a date & time change event notification containing the current date & time information to a control unit 222 every predetermined time (e.g., 1 min). The control unit 222 which has received the date & time change event notification executes received mail processing (step 504 in FIG. 7). In received mail processing, the control unit 222 stores the date & time change event notification. By looking up the matching table 221 based on the current date & time information contained in the date & time change event notification, the control unit 222 checks whether corresponding date & time designation information has been registered (step 701 in FIG. 11).

If the current date and time are Dec. 6, 2001 10:10, the determination is YES in step 702. The control unit 222 checks whether another processing start condition is added to the mail containing the date & time designation information (step 703). In the ninth embodiment, position designation information is set in addition to the date & time designation information as processing start conditions. The determination is YES in step 703, and the flow shifts to step 706.

The control unit 222 checks whether an event corresponding to the processing start condition in operation designation information acquired in step 706 has occurred (step 707). In this case, another processing start condition is position designation information, and the control unit 222 checks a position change event notification from a GPS monitoring unit 212.

If no position change event notification is generated, the control unit 222 ends received mail processing. If a position change event notification is generated, the control unit 222 stores the position change event notification. By looking up the matching table 221 based on the current date & time information contained in the previously stored date & time change event notification and the coordinate data contained in the position change event notification, the control unit 222 checks whether corresponding date & time designation information and position designation information have been registered (steps 701 and 702).

In this embodiment, the determination is YES in step 702 if the current date and time are Dec. 6, 2001 10:10 or later and the recipient holding the receiving e-mail communication apparatus 2 arrives at the position at 139° 44′ 53″ east longitude and 35° 39′ 3″ north latitude. The control unit 222 checks whether still another processing start condition is added to the mail (step 703). Since the date & time designation information and position designation information have already been read out, the determination is NO in step 703, and the flow advances to step 704. Processes in steps 704 and 705 are the same as those in the first embodiment. In the ninth embodiment, a position change event notification is generated after a date & time change event notification. These notifications may be generated in reverse.

In the ninth embodiment, for example, the sender sets a specific place as position designation information, and sets a specific date and time as date & time designation information. When the recipient is at the designated place and the designated time, the processing start conditions in operation designation information coincide with the status and date & time of the receiving e-mail communication apparatus 2. The sender can make the recipient read mail. According to the ninth embodiment, for example, cheering mail can be opened when a sports player arrives at a game field for a game. This usage prevents erroneous opening of mail when the recipient goes to the game field before the date of the game. Also, advertisement mail can be opened when a customer goes to a department store during a bargain sale. This usage inhibits opening of mail if the customer does not go to the department store during the bargain sale, pulling more customers.

[10th Embodiment]

The 10th embodiment of the present invention will be described. The arrangement and operation of an e-mail system in the 10th embodiment are the same as those in the first embodiment, and the same reference numerals as in FIGS. 1 to 11 denote the same parts. In the 10th embodiment, received mail processing starts when specific telephone communication processing is done between a terminal apparatus having a specific telephone number and a receiving e-mail communication apparatus 2 in FIG. 2 and the current date and time exceed a desired date and time. For this purpose, telephone communication designation information and date & time designation information are set as processing start conditions.

The sender sets telephone communication designation information by the same procedures as those in the second embodiment, and sets date & time designation information by the same procedures as those in the ninth embodiment. The sender sets, using an operation unit 101, an AND code by which the two pieces of information are combined by AND operation. Information obtained by combining the telephone communication designation information and date & time designation information by the AND code is set as a processing start condition in operation designation information (step 305 in FIG. 3). In this case, telephone communication designation information “termination: 03-3798-6491” and date & time designation information “to: Dec. 12, 2001 24:00” are set.

If received e-mail is assigned a mail number “3” in mail reception processing of the receiving e-mail communication apparatus 2, the telephone communication designation information “termination: 03-3798-6491” and the date & time designation information “to: Dec. 12, 2001 24:00” are stored in a matching table 221 together with the mail number “3”, as shown in FIG. 12 (step 603).

If the current date and time are Dec. 12, 2001 24:00 or earlier, the determination is YES in step 702. A control unit 222 checks whether another processing start condition is added to the mail containing the date & time designation information (step 703). In the 10th embodiment, telephone communication designation information is set in addition to the date & time designation information as processing start conditions. The determination is YES in step 703, and the flow shifts to step 706.

The control unit 222 checks whether an event corresponding to the processing start condition in operation designation information acquired in step 706 has occurred (step 707). In this case, another processing start condition is telephone communication designation information, and the control unit 222 checks a telephone communication event notification from a telephone origination/termination monitoring unit 209.

If no telephone communication event notification is generated, the control unit 222 ends received mail processing. If a telephone communication event notification is generated, the control unit 222 stores the telephone communication event notification. By looking up the matching table 221 based on the current date & time information contained in the previously stored date & time change event notification and the telephone communication processing contents and telephone number contained in the telephone communication event notification, the control unit 222 checks whether corresponding date & time designation information and telephone communication designation information have been registered (steps 701 and 702).

In this embodiment, the determination is YES in step 702 if the current date and time are Dec. 12, 2001 24:00 or earlier and the receiving e-mail communication apparatus 2 receives an incoming signal from a terminal apparatus having the telephone number “03-3798-6491”. The control unit 222 checks whether still another processing start condition is added to the mail (step 703). Since the date & time designation information and telephone communication designation information have already been read out, the determination is NO in step 703, and the flow advances to step 704. Processes in steps 704 and 705 are the same as those in the first embodiment. In the 10th embodiment, a telephone communication event notification is generated after a date & time change event notification. These notifications may be generated in reverse.

In the 10th embodiment, for example, the sender sets his/her telephone number as telephone communication designation information, and sets a specific date and time as date & time designation information. When the sender calls the receiving e-mail communication apparatus 2 at the specific date and time or later, the processing start conditions in operation designation information coincide with the status and date & time of the receiving e-mail communication apparatus 2. The sender can make the recipient read mail. According to the 10th embodiment, personnel notification mail can be opened when the recipient receives a phone call from a superior at a given time or later. This usage prevent erroneous opening of personnel notification mail due to termination before announcement.

In the eighth to 10th embodiments, two processing start conditions are set in operation designation information. Alternatively, three or more processing start conditions may be set.

[11th Embodiment]

The 11th embodiment of the present invention will be described. In the eighth to 10th embodiments, a plurality of processing start conditions in operation designation information are combined by an AND code. Instead, the present invention may employ an OR code by which a plurality of processing start conditions are combined by OR operation. The arrangement and operation of an e-mail system in the 11th embodiment are the same as those in the first embodiment, and the same reference numerals as in FIGS. 1 to 11 denote the same parts.

In the 11th embodiment, received mail processing starts when a receiving e-mail communication apparatus 2 in FIG. 2 arrives at a desired position and the current date and time exceed a desired date and time, or when specific telephone communication processing is done between a terminal apparatus having a specific telephone number and the receiving e-mail communication apparatus 2 and the current date and time exceed a desired date and time. For this purpose, information obtained by combining position designation information and date & time designation information by an AND code, and information obtained by combining telephone communication designation information and date & time designation information by an AND code are combined by an OR code.

In this case, information obtained by combining position designation information “139° 44′ 53″ east longitude and 35° 39′ 3″ north latitude” and date & time designation information “from: Dec. 6, 2001 10:10” by an AND code, and information obtained by combining telephone communication designation information “termination: 03-3798-6491” and date & time designation information “to: Dec. 12, 2001 24:00” by an AND code are combined by an OR code.

If received e-mail is assigned a mail number “4” in mail reception processing of the receiving e-mail communication apparatus 2, operation designation information in the 11th embodiment is stored in a matching table 221, as shown in FIG. 12 (step 603). As is apparent from the eighth to 10th embodiments, a plurality of processing start conditions combined by an AND code are stored on the same column of the matching table 221. Processing start conditions combined by an OR code are stored on different columns of the matching table 221.

Received mail processing in FIG. 11 is the same as those in the eighth to 10th embodiments except the presence of a plurality of columns of the matching table 221 that correspond to the same mail number. Thus, if at least one column of processing start conditions which coincide with the status and current date & time of the receiving e-mail communication apparatus 2 exists, the flow can shift to processes in steps 704 and 705.

More specifically, processes in steps 704 and 705 are executed when the current date and time are Dec. 6, 2001 10:10 or later and the recipient holding the receiving e-mail communication apparatus 2 arrives at the position at 139° 44′ 53″ east longitude and 35° 39′ 3″ north latitude, or when the current date and time are Dec. 12, 2001 24:00 or earlier and the receiving e-mail communication apparatus 2 receives an incoming signal from a terminal apparatus having the telephone number “03-3798-6491”.

[12th Embodiment]

The 12th embodiment of the present invention will be described. The arrangement and operation of an e-mail system in the 12th embodiment are the same as those in the first embodiment, and the same reference numerals as in FIGS. 1 to 11 denote the same parts. In the 12th embodiment, the sender sets action designation information in operation designation information.

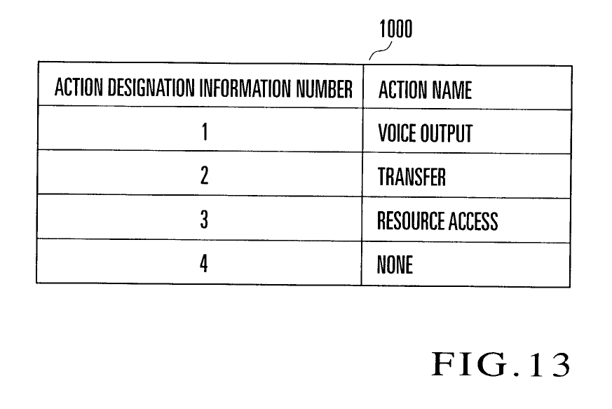

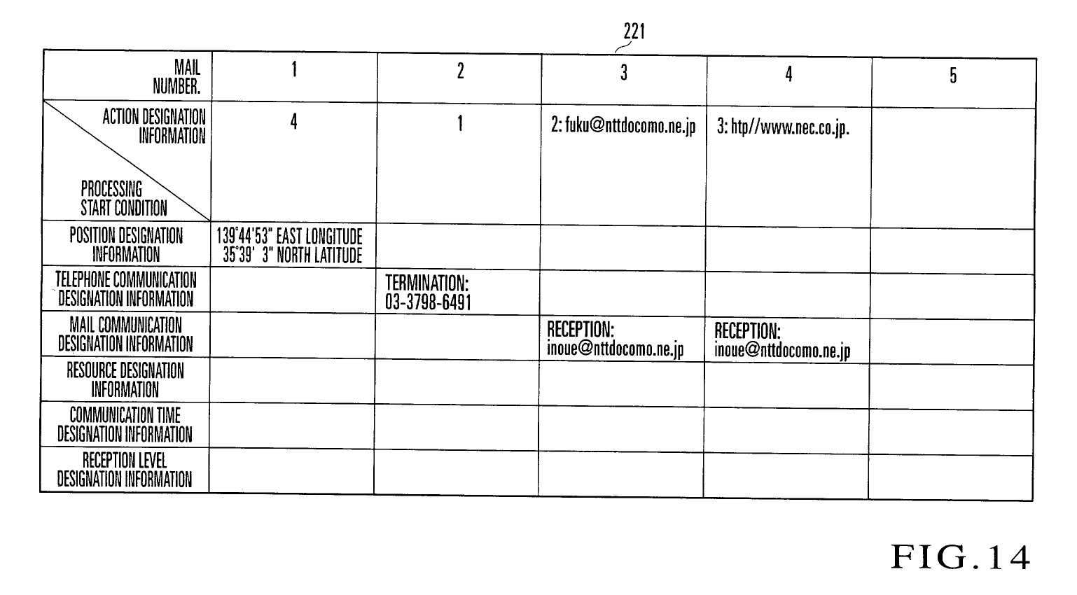

The action designation information includes “voice output” which designates voice output as received mail processing, “forward: forward destination e-mail address” which designates forward to a specific forward destination as received mail processing, “open and display” which designates opening and display as received mail processing, and “resource access: URL” which designates access to a specific resource on the Internet as received mail processing. A control unit 108 of a sending e-mail communication apparatus 1 causes a display unit 102 to display an action table 1000 as shown in FIG. 13, and adds action designation information selected by the sender to e-mail data (step 305). Pieces of action designation information “voice output”, “forward”, “resource access”, and “no selection” are assigned action designation information numbers “1”, “2”, “3”, and “4”, respectively. The action designation information “no selection” means selection of “open and display” which is preset default action designation information. The sender selects desired action designation information by its action designation information number from the displayed action table 1000. In the 12th embodiment, mail is opened and displayed when a receiving e-mail communication apparatus 2 arrives at a desired position. For this purpose, position designation information is set as a processing start condition, and “open and display”, i.e., the action designation information number “4” is set as action designation information.

The sender sets position designation information “139° 44′ 53″ east longitude and 35° 39′ 3″ north latitude” by the same procedures as those in the first embodiment, and sets the action designation information “open and display” using an operation unit 101 (step 305 in FIG. 3).

If received e-mail is assigned a mail number “1” in mail reception processing of the receiving e-mail communication apparatus 2, the position designation information “139° 44′ 53″ east longitude and 35° 39′ 3″ north latitude” and the action designation information number “4” are stored in a matching table 221 together with the mail number “1”, as shown in FIG. 14 (step 603).

Received mail processing in FIG. 11 is the same as that in the first embodiment. Since the action designation information number “4” is set in the 12th embodiment, a control unit 222 causes a display unit 202 to display received mail data extracted from an accumulation unit 205 (step 705). In the 12th embodiment, “open and display” is designated as action designation information. If the processing start condition in operation designation information set by the sender coincides with the status of the receiving e-mail communication apparatus 2, the sender can make the recipient read e-mail.

[13th Embodiment]

The 13th embodiment of the present invention will be described. The arrangement and operation of an e-mail system in the 13th embodiment are the same as those in the first embodiment, and the same reference numerals as in FIGS. 1 to 11 denote the same parts. In the 13th embodiment, mail is output by voice when specific telephone communication processing is performed between a terminal apparatus having a specific telephone number and a receiving e-mail communication apparatus 2 in FIG. 2. For this purpose, telephone communication designation information is set as a processing start condition, and “voice output” is set as action designation information.

The sender sets telephone communication designation information “termination: 03-3798-6491” by the same procedures as those in the second embodiment, and sets an action designation information number “1” using an operation unit 101 (step 305 in FIG. 3).

If received e-mail is assigned a mail number “2” in mail reception processing of the receiving e-mail communication apparatus 2, the telephone communication designation information “termination: 03-3798-6491” and the action designation information number “1” are stored in a matching table 221 together with the mail number “2”, as shown in FIG. 14 (step 603).

Received mail processing in FIG. 11 is the same as that in the second embodiment. Since the action designation information number “1” is set in the 13th embodiment, a control unit 222 executes default processing of causing a display unit 202 to display received mail data extracted from an accumulation unit 205. At the same time, the control unit 222 forwards the received mail data extracted from the accumulation unit 205 to a voice output unit 203. The voice output unit 203 converts the e-mail data into an analog voice signal, and outputs the voice from a loudspeaker (step 705). In the 13th embodiment, “voice output” is designated as action designation information. The sender can deliver his/her message to the partner at his/her intended timing with realistic sensations.

[14th Embodiment]

The 14th embodiment of the present invention will be described. The arrangement and operation of an e-mail system in the 14th embodiment are the same as those in the first embodiment, and the same reference numerals as in FIGS. 1 to 11 denote the same parts. In the 14th embodiment, mail is forwarded to another forward destination when specific mail communication processing is performed between a terminal apparatus having a specific e-mail address and a receiving e-mail communication apparatus 2 in FIG. 2. For this purpose, mail communication designation information is set as a processing start condition, and “forward: forward destination e-mail address” is set as action designation information.

The sender sets mail communication designation information “reception: inoue@nttdocomo.ne.jp” by the same procedures as those in the third embodiment, and sets action designation information “2: fuku@nttdocomo.ne.jp” using an operation unit 101 (step 305 in FIG. 3).

If received e-mail is assigned a mail number “3” in mail reception processing of the receiving e-mail communication apparatus 2, the mail communication designation information “reception: inoue@nttdocomo.ne.jp” and the action designation information “2: fuku@nttdocomo.ne.jp” are stored in a matching table 221 together with the mail number “3”, as shown in FIG. 14 (step 603).

Received mail processing in FIG. 11 is the same as that in the third embodiment. Since the action designation information number “2” is set in the 14th embodiment, a control unit 222 executes default processing of causing a display unit 202 to display received mail data extracted from an accumulation unit 205. At the same time, the control unit 222 forwards the received mail data extracted from the accumulation unit 205 to a mail sending unit 206. The mail sending unit 206 connects the receiving e-mail communication apparatus 2 to a communication network (not shown), and sends the e-mail data from the control unit 222 to the forward destination e-mail address “fuku@nttdocomo.ne.jp” in the action designation information (step 705). In the 14th embodiment, “forward: forward destination e-mail address” is designated as action designation information. A message can be sequentially delivered to people, like a top down document.

[15th Embodiment]

The 15th embodiment of the present invention will be described. The arrangement and operation of an e-mail system in the 15th embodiment are the same as those in the first embodiment, and the same reference numerals as in FIGS. 1 to 11 denote the same parts. In the 15th embodiment, a receiving e-mail communication apparatus 2 is caused to access a specific resource on the Internet when a processing start condition and the status of the receiving e-mail communication apparatus 2 coincide with each other. For this purpose, “resource access: URL” is set as action designation information.

The sender sets, e.g., mail communication designation information “reception: inoue@nttdocomo.ne.jp” as a processing start condition by the same procedures as those in the above embodiment, and sets action designation information “3: URL (e.g., http://www.nec.co.jp)” using an operation unit 101 (step 305 in FIG. 3).

If received e-mail is assigned a mail number “4” in mail reception processing of the receiving e-mail communication apparatus 2, the mail communication designation information “reception: inoue@nttdocomo.ne.jp” and the action designation information “3: http://www.nec.co.jp” are stored in a matching table 221 together with the mail number “4”, as shown in FIG. 14 (step 603).

Received mail processing in FIG. 11 is the same as that in the above embodiment. Since the action designation information number “3” is set in the 15th embodiment, a control unit 222 instructs a browser 215 to access a resource with the URL “http://www.nec.co.jp” designated in the action designation information (step 705). In the 15th embodiment, “resource access: URL” is designated as action designation information, and the receiving e-mail communication apparatus 2 can be made to access a specific resource on the Internet.

[16th Embodiment]

The 16th embodiment of the present invention will be described. The arrangement and operation of an e-mail system in the 16th embodiment are the same as those in the first embodiment, and the same reference numerals as in FIGS. 1 to 11 denote the same parts. In the 16th embodiment, received mail processing starts upon a change in the presence (status) of a specific e-mail communication apparatus among a plurality of e-mail communication apparatuses including a receiving e-mail communication apparatus 2 that participate in an instant message service. For this purpose, instant message service designation information is set as a processing start condition.

The instant message service designation information is formed from an e-mail address. To start received mail processing when the presence of an e-mail communication apparatus having a specific e-mail address changes, the sender inputs the specific mail address using an operation unit 101 of a sending e-mail communication apparatus 1 in FIG. 1. In this fashion, the instant message service designation information is set as a processing start condition in operation designation information (step 305 in FIG. 3).

In mail reception processing of the receiving e-mail communication apparatus 2, the instant message service designation information of received e-mail is stored in a matching table 221 together with a mail number assigned to the e-mail (step 603 in FIG. 8).

The statuses (presence information) of a plurality of e-mail communication apparatuses which participate in the instant message service can be recognized by an event notification from the base station. A control unit 222 of the receiving e-mail communication apparatus 2 which has received a notification from the base station performs received mail processing (step 504 in FIG. 7). In received mail processing, the control unit 222 checks whether corresponding instant message service designation information has been registered, by looking up the matching table 221 on the basis of the mail address of an e-mail communication apparatus in the changed presence notified by the base station (step 701 in FIG. 11).

If the corresponding instant message service designation information has been registered, the control unit 222 checks whether another processing start condition is added to the mail containing the instant message service designation information (step 703). Since only the instant message service designation information is set as a processing start condition, the control unit 222 acquires the mail number of the mail from the matching table 221 (step 704). Processing in step 705 is the same as that in the first embodiment. In the 16th embodiment, the sender can make the receiving e-mail communication apparatus 2 process received mail in response to a change in the presence of an e-mail communication apparatus intended by the sender.

Note that received mail processing may start upon a change in the presence of at least one of a plurality of e-mail communication apparatuses which participate in an instant message service. In this case, the sender sets instant message service designation information with a blank mail address. The base station notifies the control unit 222 of the receiving e-mail communication apparatus 2 of a change in the presence of an e-mail communication apparatus registered in advance as an instant message service participator. The control unit 222 refers to the matching table 221, and if the instant message service designation information with a blank mail address has been registered, determines YES in step 702. Accordingly, e-mail containing the instant message service designation information is processed. Even if the sender does not designate a specific e-mail communication apparatus, the receiving e-mail communication apparatus 2 can be made to process received mail upon a change in the presence of at least one of a plurality of e-mail communication apparatuses which participate in the instant message service.

[17th Embodiment]

The 17th embodiment of the present invention will be described. The arrangement and operation of an e-mail system in the 17th embodiment are the same as those in the first embodiment, and the same reference numerals as in FIGS. 1 to 11 denote the same parts. In the 17th embodiment, received mail processing starts when the distance between a specific terminal apparatus and a receiving e-mail communication apparatus 2 is longer or shorter than a predetermined value. For this purpose, distance designation information is set as a processing start condition.

The distance designation information includes a distance threshold used to start received mail processing by the receiving e-mail communication apparatus 2, and information which designates whether to start received mail processing when the distance between a specific terminal apparatus and the receiving e-mail communication apparatus 2 is longer or shorter than the distance threshold. In the 17th embodiment, received mail processing starts when the distance between a specific terminal apparatus and the receiving e-mail communication apparatus 2 is shorter than the distance threshold. For this purpose, the sender sets distance designation information “shorter than the distance threshold” using an operation unit 101 of a sending e-mail communication apparatus 1. As a result, the distance designation information is set as a processing start condition in operation designation information (step 305 in FIG. 3).

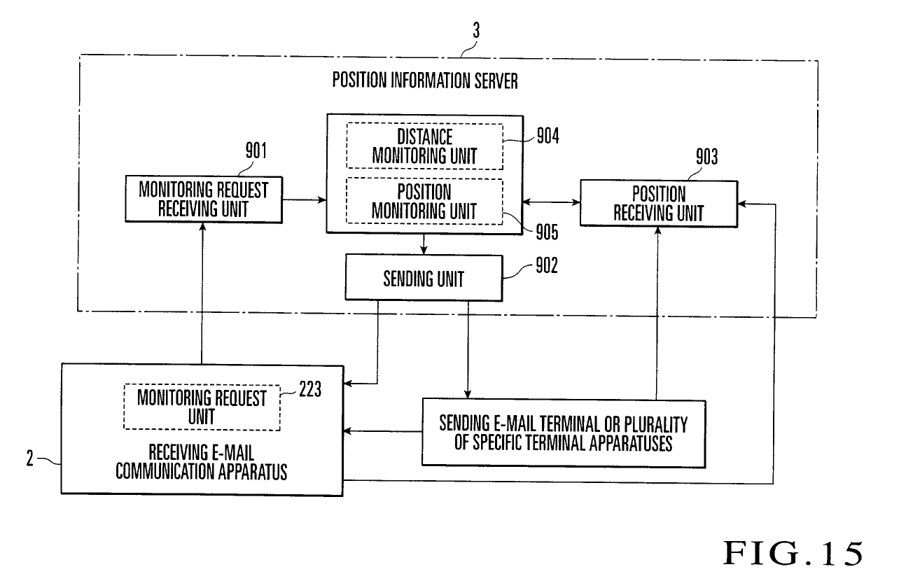

In mail reception processing of the receiving e-mail communication apparatus 2, distance designation information of received e-mail is stored in a matching table 221 together with a mail number assigned to the e-mail (step 603 in FIG. 8). A monitoring request unit 223 of the receiving e-mail communication apparatus 2 registers the telephone numbers or e-mail addresses of the receiving e-mail communication apparatus 2 and specific terminal apparatus in a position information server 3 shown in FIG. 15. If the telephone numbers or e-mail addresses of the receiving e-mail communication apparatus 2 and specific terminal apparatus are registered via a monitoring request receiving unit 901, a distance monitoring unit 904 of the position information server 3 communicates with the receiving e-mail communication apparatus 2 and specific terminal apparatus via a sending unit 902. A position receiving unit 903 detects the positions of the receiving e-mail communication apparatus 2 and specific terminal apparatus, thereby detecting the distance between the receiving e-mail communication apparatus 2 and the specific terminal apparatus. The receiving e-mail communication apparatus 2 is notified of the detected distance via the sending unit 902.

A control unit 222 of the receiving e-mail communication apparatus 2 which has received the notification from the position information server 3 executes received mail processing (step 504 in FIG. 7). In received mail processing, the control unit 222 checks whether corresponding distance designation information has been registered, by looking up the matching table 221 based on distance information contained in the event notification from the position information server 3 (step 701 in FIG. 11). If the notified distance is shorter than a distance threshold designated by the distance designation information, the determination is YES in step 702.

If the corresponding distance designation information has been registered, the control unit 222 checks whether another processing start condition is added to the mail containing the distance designation information (step 703). Since only the distance designation information is set as a processing start condition, the control unit 222 acquires the mail number of the mail from the matching table 221 (step 704). Processing in step 705 is the same as that in the first embodiment. In the 17th embodiment, the sender can make the receiving e-mail communication apparatus 2 process received mail in accordance with whether the distance between a specific terminal apparatus intended by the sender and the receiving e-mail communication apparatus 2 is longer or shorter than a distance threshold.

The 17th embodiment has exemplified one specific terminal apparatus, but the number of specific terminal apparatuses is not limited to one. The receiving e-mail communication apparatus 2 may be made to process received mail when the distances between a plurality of specific terminal apparatuses and the receiving e-mail communication apparatus 2 are longer or shorter than a distance threshold. In this case, a plurality of specific terminal apparatuses are registered in the position information server 3 from the receiving e-mail communication apparatus 2. The position information server 3 detects distances between the plurality of specific terminal apparatuses and the receiving e-mail communication apparatus 2, and notifies the receiving e-mail communication apparatus 2 of a plurality of distances. In the 17th embodiment, the receiving e-mail communication apparatus 2 receives a distance notification from the position information server 3. Alternatively, the receiving e-mail communication apparatus 2 may receive a notification about the position of a specific terminal apparatus from the position information server 3, and calculate the distance between the receiving e-mail communication apparatus 2 and the specific terminal apparatus.

Instead of receiving a position notification from the position information server 3, the receiving e-mail communication apparatus 2 may receive a position notification from one or a plurality of specific terminal apparatuses. In the receiving e-mail communication apparatus 2 which has received e-mail containing distance designation information from the sending e-mail communication apparatus 1, the monitoring request unit 223 sends a position notification request to one or a plurality of specific terminal apparatuses designated by the distance designation information. One or a plurality of specific terminal apparatuses have GPS monitoring units, can detect their positions, and notify the receiving e-mail communication apparatus 2 of their positions in response to a request from the receiving e-mail communication apparatus 2. The control unit 222 of the receiving e-mail communication apparatus 2 receives a position notification from a specific terminal apparatus, and calculates the distance between the receiving e-mail communication apparatus 2 and the specific terminal apparatus.

[18th Embodiment]

The 18th embodiment of the present invention will be described. The arrangement and operation of an e-mail system in the 18th embodiment are the same as those in the first embodiment, and the same reference numerals as in FIGS. 1 to 11 denote the same parts. In the 18th embodiment, received mail processing starts when another e-mail does not reach the mail server upon reception of e-mail with a processing start condition. For this purpose, unreached status designation information is set as a processing start condition.

The unreached status designation information is information which designates a status wherein no new e-mail reaches the mail server. To start received mail processing when no e-mail reaches the mail server, the sender sets unreached status designation information using an operation unit 101 of a sending e-mail communication apparatus 1 in FIG. 1 (step 305 in FIG. 3).

In mail reception processing of a receiving e-mail communication apparatus 2, unreached status designation information of received e-mail is stored in a matching table 221 together with a mail number assigned to the e-mail (step 603 in FIG. 8). As described in the third embodiment, when the receiving e-mail communication apparatus 2 performs mail communication processing, a mail monitoring unit 207 sends a mail communication event notification to a control unit 222. The control unit 222 which has received the mail communication event notification executes received mail processing (step 504 in FIG. 7). In received mail processing, if mail communication processing contents contained in the mail communication event notification represent reception processing and no received mail in the mail server, the control unit 222 refers to the matching table 221 and checks whether corresponding unreached status designation information has been registered (step 701 in FIG. 11).

If the corresponding unreached status designation information has been registered in the matching table 221, the control unit 222 checks whether another processing start condition is added to the mail containing the unreached status designation information (step 703). Since only the unreached status designation information is set as a processing start condition, the control unit 222 acquires the mail number of the mail from the matching table 221 (step 704). Processing in step 705 is the same as that in the first embodiment.

In the 18th embodiment, the sender adds unreached status designation information to, e.g., advertisement mail, and sends the mail to the receiving e-mail communication apparatus 2. If no received mail exists in the mail server in access to the mail server by the receiving e-mail communication apparatus 2 upon reception of the advertisement mail, the receiving e-mail communication apparatus 2 can be made to execute processing of, e.g., displaying the advertisement mail.

[19th Embodiment]

The 19th embodiment of the present invention will be described. The arrangement and operation of an e-mail system in the 19th embodiment are the same as those in the first embodiment, and the same reference numerals as in FIGS. 1 to 11 denote the same parts. In the 19th embodiment, the sender sets processing count designation information in operation designation information.

The sender sets, e.g., mail communication designation information “reception: inoue@nttdocomo.ne.jp” as a processing start condition by the same procedures as those in the above embodiment, and sets processing count designation information using an operation unit 101 (step 305 in FIG. 3). In mail reception processing of a receiving e-mail communication apparatus 2, mail communication designation information and processing count designation information of received e-mail are stored in a matching table 221 together with a mail number assigned to the e-mail (step 603 in FIG. 8).

Received mail processing in FIG. 11 is the same as that in the above embodiment. In the 19th embodiment, the log of the processing count of the received mail containing the processing count designation information is stored in a control unit 222. If the log of the processing count of the received mail exceeds a count designated by the processing count designation information when processing the received mail containing the processing count designation information, the control unit 222 does not process the received mail.

In the 19th embodiment, the sender can set processing count designation information, and make the receiving e-mail communication apparatus 2 process received mail by a designated count. For example, image information such as an incoming picture to be displayed on the receiving e-mail communication apparatus 2 is attached to e-mail in which processing count designation information is set. Further, “open and display” is set as action designation information. The incoming picture can be displayed every processing of the e-mail unless the log of the processing count of the e-mail exceeds a count designated by the processing count designation information. The sender need not repetitively send the same image, reducing the communication cost. Also, cumbersome registration of the incoming picture in the receiving e-mail communication apparatus 2 can be eliminated.

E-mail containing the above-described processing count designation information is used as, e.g., advertisement mail. It is therefore preferable to set and change the processing count in accordance with recipient's needs. In other words, the receiving e-mail communication apparatus 2 can set and change processing count designation information added to received mail in accordance with recipient's needs.

[20th Embodiment]

The 20th embodiment of the present invention will be described. The arrangement and operation of an e-mail system in the 20th embodiment are the same as those in the first embodiment, and the same reference numerals as in FIGS. 1 to 11 denote the same parts. In the 20th embodiment, the sender sets automatic update designation information in operation designation information.

The automatic update designation information designates whether to automatically update received mail. The sender sets, e.g., mail communication designation information “reception: inoue@nttdocomo.ne.jp” as a processing start condition by the same procedures as those in the above embodiment, and sets automatic update designation information using an operation unit 101 (step 305 in FIG. 3). In mail reception processing of a receiving e-mail communication apparatus 2, mail communication designation information and automatic update designation information of received e-mail are stored in a matching table 221 together with a mail number assigned to the e-mail (step 603 in FIG. 8).

Upon reception of the e-mail containing the automatic update designation information, a control unit 222 of the receiving e-mail communication apparatus 2 checks whether the same automatic update designation information has been registered, by looking up the matching table 221 based on the automatic update designation information. If the same automatic update designation information has been registered in the matching table 221 and the automatic update designation information of the newly received e-mail designates “automatic update”, the control unit 222 invalidates the past received mail containing the same automatic update designation information, and updates the past received mail to the newly received e-mail.

In the 20th embodiment, the sender can set automatic update designation information, and update e-mail stored in the receiving e-mail communication apparatus 2 at his/her intended timing. For example, image information such as an incoming picture to be displayed on the receiving e-mail communication apparatus 2 is attached to e-mail in which automatic update designation information is set. In addition, “open and display” is set as action designation information, and “automatic update” is set as automatic update designation information. Image information such as an incoming picture sent in the past is updated to newly sent image information. The latest incoming picture can be displayed on the receiving e-mail communication apparatus 2.

E-mail containing the above-described automatic update designation information is used as, e.g., advertisement mail. It is therefore preferable to set and change automatic update designation information in accordance with recipient's needs. That is, the receiving e-mail communication apparatus 2 can set and change automatic update designation information added to received mail in accordance with recipient's needs. Whether to enable setting and changing automatic update designation information in the receiving e-mail communication apparatus 2 can be selected in setting automatic update designation information in the sending e-mail communication apparatus 1.

[21st Embodiment]

The 21st embodiment of the present invention will be described. The arrangement and operation of an e-mail system in the 21st embodiment are the same as those in the first embodiment, and the same reference numerals as in FIGS. 1 to 11 denote the same parts. In the 21st embodiment, the sender sets valid term designation information in operation designation information.

The sender sets, e.g., mail communication designation information “reception: inoue@nttdocomo.ne.jp” as a processing start condition by the same procedures as those in the above embodiment, and sets valid term designation information using an operation unit 101 (step 305 in FIG. 3). In mail reception processing of a receiving e-mail communication apparatus 2, mail communication designation information “reception: inoue@nttdocomo.ne.jp” and valid term designation information of received e-mail are stored in a matching table 221 together with a mail number assigned to the e-mail (step 603 in FIG. 8).

Received mail processing in FIG. 11 is the same as that in the above embodiment. If a date and time (or current date and time) lapsed from the mail reception date and time exceed a valid term designated by valid term designation information when processing received mail containing the valid term designation information, a control unit 222 of the receiving e-mail communication apparatus 2 does not process the received mail.

In the 21st embodiment, the sender can set valid term designation information, and make the receiving e-mail communication apparatus 2 process received mail only within the valid term. For example, image information such as an incoming picture to be displayed on the receiving e-mail communication apparatus 2 is attached to e-mail in which valid term designation information is set. Further, “open and display” is set as action designation information. The incoming picture can be displayed every processing of the e-mail within the valid term.

E-mail containing the above-described valid term designation information is used as, e.g., advertisement mail. It is preferable to set and change the processing count in accordance with recipient's needs. That is, the receiving e-mail communication apparatus 2 can set and change valid term designation information added to received mail in accordance with recipient's needs.

[22nd Embodiment]

The 22nd embodiment of the present invention will be described. The arrangement and operation of an e-mail system in the 22nd embodiment are the same as those in the first embodiment, and the same reference numerals as in FIGS. 1 to 11 denote the same parts. In the first embodiment, mail processing starts when a receiving e-mail communication apparatus 2 arrives at a desired position. Mail processing may start when the receiving e-mail communication apparatus 2 and one or a plurality of specific terminal apparatuses arrive at desired positions. In this case, it is set as a processing start condition (position designation information) to monitor the position of the receiving e-mail communication apparatus 2 and the positions of one or a plurality of specific terminal apparatuses. A specific terminal apparatus is designated by the telephone number or e-mail address of the terminal apparatus.

A monitoring request unit 223 of the receiving e-mail communication apparatus 2 registers the telephone numbers or e-mail addresses of one or a plurality of specific terminal apparatuses in a position information server 3 shown in FIG. 15. After the telephone numbers or e-mail addresses of one or a plurality of specific terminal apparatuses are registered via a monitoring request receiving unit 901, a position monitoring unit 905 of the position information server 3 communicates with one or a plurality of specific terminal apparatuses via a sending unit 902. A position receiving unit 903 detects the positions of one or a plurality of specific terminal apparatuses. The receiving e-mail communication apparatus 2 is notified of coordinate data of the detected positions via the sending unit 902.

In received mail processing in step 504 of FIG. 7, a control unit 222 of the receiving e-mail communication apparatus 2 checks whether corresponding position designation information has been registered, by looking up a matching table 221 based on coordinate data contained in a position change event notification from a GPS monitoring unit 212 and coordinate data contained in an event notification from the position information server 3 (step 701 in FIG. 11). The determination is YES in step 702 if the coordinate data of the receiving e-mail communication apparatus 2 contained in the position change event notification and coordinate data contained in position designation information coincide with each other, and the coordinate data of one or a plurality of specific terminal apparatuses contained in the notification from the position information server 3 and the coordinate data contained in the position designation information coincide with each other.

If the corresponding position designation information has been registered, the control unit 222 checks whether another processing start condition is added to the mail containing the position designation information (step 703). Since only the position designation information is set as a processing start condition, the control unit 222 acquires the mail number of the mail from the matching table 221 (step 704). Processing in step 705 is the same as that in the first embodiment. In the 22nd embodiment, the sender can make the receiving e-mail communication apparatus 2 process received mail when the receiving e-mail communication apparatus 2 and one or a plurality of specific terminal apparatuses arrive at desired positions.

[23rd Embodiment]

The 23rd embodiment of the present invention will be described. The arrangement and operation of an e-mail system in the 23rd embodiment are the same as those in the first embodiment, and the same reference numerals as in FIGS. 1 to 11 denote the same parts. In the first embodiment, mail processing starts when a receiving e-mail communication apparatus 2 arrives at a desired position. Mail processing may start when one or a plurality of specific terminal apparatuses arrive at desired positions. In this case, it is set as a processing start condition (position designation information) to monitor not the position of the receiving e-mail communication apparatus 2 but the positions of one or a plurality of specific terminal apparatuses. Similar to the 22nd embodiment, a monitoring request unit 223 of the receiving e-mail communication apparatus 2 registers the telephone numbers or e-mail addresses of one or a plurality of specific terminal apparatuses in a position information server 3.

In received mail processing in step 504 of FIG. 7, a control unit 222 of the receiving e-mail communication apparatus 2 checks whether corresponding position designation information has been registered, by looking up a matching table 221 based on coordinate data contained in an event notification from the position information server 3 (step 701 in FIG. 11). If the coordinate data of one or a plurality of specific terminal apparatuses contained in the notification from the position information server 3 and coordinate data contained in position designation information coincide with each other, the determination is YES in step 702.

If the corresponding position designation information has been registered, the control unit 222 checks whether another processing start condition is added to the mail containing the position designation information (step 703). Since only the position designation information is set as a processing start condition, the control unit 222 acquires the mail number of the mail from the matching table 221 (step 704). Processing in step 705 is the same as that in the first embodiment. In the 23rd embodiment, the sender can make the receiving e-mail communication apparatus 2 process received mail when one or a plurality of specific terminal apparatuses arrive at desired positions.

It is apparent that the present invention is not limited to the above-described embodiments and each embodiment can be properly modified within the technical scope of the present invention. In the present invention, a combination of the processing start condition and action designation information is not limited to those in the first to 14th embodiments, and can be another combination. In the first to 14th embodiments, the receiving e-mail communication apparatus 2 comprises seven monitoring units: the mail monitoring unit 207, telephone origination/termination monitoring unit 209, communication time monitoring unit 210, GPS monitoring unit 212, timer monitoring unit 214, URL monitoring unit 216, reception level monitoring unit 218, and password monitoring unit 219. The receiving e-mail communication apparatus 2 need not be equipped with all these monitoring units, and one or a plurality of necessary monitoring units may be arranged in accordance with a processing start condition used.

According to the present invention, when the status of the receiving e-mail communication apparatus or the status of another specific terminal apparatus coincides with a processing start condition set by the sending e-mail communication apparatus, e-mail containing the processing start condition is processed by the receiving e-mail communication apparatus. The sender can make the receiving e-mail communication apparatus process received mail at his/her intended timing. Since e-mail can be sent in advance, simultaneous sending of many mail messages to the mail server can be prevented, distributing the burden on the mail server.

When the status of the receiving e-mail communication apparatus or the status of another specific terminal apparatus coincides with a processing start condition set by the sending e-mail communication apparatus, and the date and time of date & time designation information contained in the processing start condition coincide with the current date and time, e-mail containing the processing start condition is processed by the receiving e-mail communication apparatus. The sender can make the receiving e-mail communication apparatus process received mail at his/her intended timing. Since e-mail can be sent in advance, simultaneous sending of many mail messages to the mail server can be prevented, distributing the burden on the mail server.

When a position designated by position designation information in a processing start condition set by the sending e-mail communication apparatus coincides with the position of the receiving e-mail communication apparatus, e-mail containing the processing start condition is processed by the receiving e-mail communication apparatus. The sender can make the receiving e-mail communication apparatus process received mail at his/her intended place.

When telephone communication processing designated by telephone communication designation information in a processing start condition set by the sending e-mail communication apparatus is executed by the receiving e-mail communication apparatus, e-mail containing the processing start condition is processed by the receiving e-mail communication apparatus. The sender can make the receiving e-mail communication apparatus process received mail in response to his/her intended telephone communication processing.

When mail communication processing designated by mail communication designation information in a processing start condition set by the sending e-mail communication apparatus is performed by the receiving e-mail communication apparatus, e-mail containing the processing start condition is processed by the receiving e-mail communication apparatus. The sender can make the receiving e-mail communication apparatus process received mail in response to his/her intended mail communication processing.

When access designated by resource designation information in a processing start condition set by the sending e-mail communication apparatus is done by the receiving e-mail communication apparatus, e-mail containing the processing start condition is processed by the receiving e-mail communication apparatus. The sender can make the receiving e-mail communication apparatus process received mail in response to his/her intended Internet access.

When the communication time exceeds a predetermined value designated by communication time designation information in a processing start condition set by the sending e-mail communication apparatus, e-mail containing the processing start condition is processed by the receiving e-mail communication apparatus. The sender can make the receiving e-mail communication apparatus process received mail in accordance with his/her intended communication time.

When the reception level of radio waves received from the base station by the receiving e-mail communication apparatus satisfies a relationship in magnitude designated by reception level designation information in a processing start condition set by the sending e-mail communication apparatus, e-mail containing the processing start conditions is processed by the receiving e-mail communication apparatus. The sender can make the receiving e-mail communication apparatus process received mail in accordance with his/her intended reception level.

When the recipient inputs a password designated by password designation information in a processing start condition set by the sending e-mail communication apparatus, e-mail containing the processing start condition is processed by the receiving e-mail communication apparatus. The sender can make the receiving e-mail communication apparatus process received mail in response to input of his/her intended password.

When a position designated by position designation information in a processing start condition set by the sending e-mail communication apparatus coincides with the position of the receiving e-mail communication apparatus, and telephone communication processing designated by telephone communication designation information in the processing start condition is executed by the receiving e-mail communication apparatus, e-mail containing the processing start conditions is processed by the receiving e-mail communication apparatus. The sender can make the receiving e-mail communication apparatus process received mail in response to his/her intended place and telephone communication processing.

When a position designated by position designation information in a processing start condition set by the sending e-mail communication apparatus coincides with the position of the receiving e-mail communication apparatus, and the date and time of date & time designation information contained in the processing start condition coincide with the current date and time, e-mail containing the processing start conditions is processed by the receiving e-mail communication apparatus. The sender can make the receiving e-mail communication apparatus process received mail at his/her intended place, date, and time.

When telephone communication processing designated by telephone communication designation information in a processing start condition set by the sending e-mail communication apparatus is executed by the receiving e-mail communication apparatus, and the date and time of date & time designation information contained in the processing start condition coincide with the current date and time, e-mail containing the processing start conditions is processed by the receiving e-mail communication apparatus. The sender can make the receiving e-mail communication apparatus process received mail in response to his/her intended date, time, and telephone communication processing.

Processing designated by action designation information is performed when e-mail containing a processing start condition is processed. The sender can make the receiving e-mail communication apparatus execute his/her intended processing.

By designating voice output as received mail processing in action designation information, not only a document is opened and displayed, but also the mail message can be delivered by voice.

By designating forward to a specific forward destination as received mail processing in action designation information, a message can be sequentially delivered, like a top down document.

By designating access to a specific resource on the Internet as received mail processing in action designation information, the receiving e-mail communication apparatus can be made to access the specific resource on the Internet.

Upon a change in the presence of a specific e-mail communication apparatus designated by instant message service designation information in a processing start condition set by the sending e-mail communication apparatus, e-mail containing the processing start condition is processed by the receiving e-mail communication apparatus. The sender can make the receiving e-mail communication apparatus process received mail upon a change in the presence of his/her intended e-mail communication apparatus.

When the presence of at least one of a plurality of e-mail communication apparatuses changes upon reception of e-mail to which a processing start condition containing instant message service designation information is added, the e-mail containing the processing start condition is processed by the receiving e-mail communication apparatus. The sender can make the receiving e-mail communication apparatus process received mail upon a change in the presence of at least one e-mail communication apparatus.

When the distances between one or a plurality of specific terminal apparatuses and the receiving e-mail communication apparatus satisfy a relationship in magnitude designated by distance designation information in a processing start condition added to received e-mail, the e-mail containing the processing start condition is processed by the receiving e-mail communication apparatus. The sender can make the receiving e-mail communication apparatus process received mail in response to the case wherein the distances between one or a plurality of specific terminal apparatuses intended by the sender and the receiving e-mail communication apparatus are longer or shorter than a predetermined value.

If e-mail addressed to the receiving e-mail communication apparatus does not reach the mail server in access to the mail server upon reception of e-mail to which a processing start condition containing unreached status designation information is added, the e-mail containing the processing start condition is processed by the receiving e-mail communication apparatus. The sender adds unreached status designation information to, e.g., advertisement mail, and sends the e-mail to the receiving e-mail communication apparatus. If no received mail exists in the mail server in access to the mail server by the receiving e-mail communication apparatus upon reception of the advertisement mail, the receiving e-mail communication apparatus can be made to execute processing of, e.g., displaying the advertisement mail.

By setting processing count designation information, the sender can make the receiving e-mail communication apparatus process received mail by a designated count.

The receiving e-mail communication apparatus can set and change processing count designation information added to received mail in accordance with recipient's needs.

By setting automatic update designation information, the sender can update e-mail stored in the receiving e-mail communication apparatus at his/her intended timing.

The receiving e-mail communication apparatus can set and change automatic update designation information added to received mail in accordance with recipient's needs.

By setting valid term designation information, the sender can make the receiving e-mail communication apparatus process received mail only within the valid term.

The receiving e-mail communication apparatus can set and change valid term designation information added to received mail in accordance with recipient's needs.

When the position of the receiving e-mail communication apparatus and the positions of one or a plurality of specific terminal apparatuses coincide with positions designated by position designation information in a processing start condition, e-mail containing the processing start condition is processed by the receiving e-mail communication apparatus. The sender can make the receiving e-mail communication apparatus process received mail when the receiving e-mail communication apparatus and one or a plurality of specific terminal apparatuses intended by the sender arrive at desired positions.

When the positions of one or a plurality of specific terminal apparatuses coincide with positions designated by position designation information in a processing start condition, e-mail containing the processing start condition is processed by the receiving e-mail communication apparatus. The sender can make the receiving e-mail communication apparatus process received mail when one or a plurality of specific terminal apparatuses intended by the sender arrive at desired positions.

What is claimed is:

1. An e-mail sending/receiving method comprising:
the setting step of setting, by a sending e-mail communication apparatus, a processing start condition representing a condition under which a receiving e-mail communication apparatus starts received mail processing;
the sending step of adding the set processing start condition to e-mail and sending the e-mail from the sending e-mail communication apparatus to the receiving e-mail communication apparatus;
the receiving step of receiving the e-mail sent from the sending e-mail communication apparatus by the receiving e-mail communication apparatus;
the monitoring step of monitoring a status of the receiving e-mail communication apparatus or a status of another specific terminal apparatus; and
the determining step of, when the status of the receiving e-mail communication apparatus or the status of the specific terminal apparatus coincides with the processing start condition added to the received e-mail, processing the e-mail containing the processing start condition by the receiving e-mail communication apparatus.

2. A method according to claim 1, wherein
the monitoring step comprises a step of monitoring a status of the receiving e-mail communication apparatus or a status of another specific terminal apparatus, and a current date and time, and
the determining step comprises a step of, when the status of the receiving e-mail communication apparatus or the status of the specific terminal apparatus coincides with the processing start condition added to the received e-mail and a date and time of date & time designation information contained in the processing start condition coincide with the current date and time, processing the e-mail containing the processing start condition by the receiving e-mail communication apparatus.

3. A method according to claim 1, wherein
the processing start condition includes position designation information which starts received mail processing when the receiving e-mail communication apparatus reaches a desired position,
in the monitoring step, a position of the receiving e-mail communication apparatus is monitored, and
in the determining step, the e-mail containing the processing start condition is processed when the position designated by the position designation information in the processing start condition added to the received e-mail coincides with the position of the receiving e-mail communication apparatus.

4. A method according to claim 1, wherein
the processing start condition includes telephone communication designation information which starts received mail processing when specific telephone communication processing is performed between a terminal apparatus having a specific telephone number and the receiving e-mail communication apparatus,
in the monitoring step, telephone communication processing of the receiving e-mail communication apparatus is monitored, and
in the determining step, the e-mail containing the processing start condition is processed when the receiving e-mail communication apparatus performs the telephone communication processing designated by the telephone communication designation information in the processing start condition added to the received e-mail.

5. A method according to claim 1, wherein
the processing start condition includes mail communication designation information which starts received mail processing when specific mail communication processing is performed between a terminal apparatus having a specific e-mail address and the receiving e-mail communication apparatus,
in the monitoring step, mail communication processing of the receiving e-mail communication apparatus is monitored, and
in the determining step, the e-mail containing the processing start condition is processed when the receiving e-mail communication apparatus performs the mail communication processing designated by the mail communication designation information in the processing start condition added to the received e-mail.

6. A method according to claim 1, wherein
the processing start condition includes resource designation information which starts received mail processing when the receiving e-mail communication apparatus accesses a specific resource on Internet,
in the monitoring step, access to the Internet by the receiving e-mail communication apparatus is monitored, and
in the determining step, the e-mail containing the processing start condition is processed when the receiving e-mail communication apparatus performs access designated by the resource designation information in the processing start condition added to the received e-mail.

7. A method according to claim 1, wherein
the processing start condition includes communication time designation information which starts received mail processing when a communication time of the receiving e-mail communication apparatus exceeds a predetermined value,
in the monitoring step, a communication time of the receiving e-mail communication apparatus is monitored, and
in the determining step, the e-mail containing the processing start condition is processed when the communication time of the receiving e-mail communication apparatus exceeds the predetermined value designated by the communication time designation information in the processing start condition added to the received e-mail.

8. A method according to claims 1, wherein
the processing start condition includes position designation information which starts received mail processing when the receiving e-mail communication apparatus reaches a desired position, and telephone communication designation information which starts received mail processing when specific telephone communication processing is performed between a terminal apparatus having a specific telephone number and the receiving e-mail communication apparatus,
in the monitoring step, a position of the apparatus and telephone communication processing of the apparatus are monitored, and
in the determining step, the e-mail containing the processing start condition is processed when the position designated by the position designation information in the processing start condition added to the received e-mail coincides with the position of the receiving e-mail communication apparatus and the receiving e-mail communication apparatus performs the telephone communication processing designated by the telephone communication designation information in the processing start condition.

9. A method according to claim 2, wherein
the processing start condition includes position designation information which starts received mail processing when the receiving e-mail communication apparatus reaches a desired position, and date & time designation information which designates a desired date and time,
in the monitoring step, a current date and time and a position of the receiving e-mail communication apparatus are monitored, and
in the determining step, the e-mail containing the processing start condition is processed when the position designated by the position designation information in the processing start condition added to the received e-mail coincides with the position of the receiving e-mail communication apparatus and the date and time of the date & time designation information contained in the processing start condition coincide with the current date and time.

10. A method according to claim 2, wherein
the processing start condition includes telephone communication designation information which starts received mail processing when specific telephone communication processing is performed between a terminal apparatus having a specific telephone number and the receiving e-mail communication apparatus, and date & time designation information which designates a desired date and time,
in the monitoring step, a current date and time and telephone communication processing of the receiving e-mail communication apparatus are monitored, and
in the determining step, the e-mail containing the processing start condition is processed when the receiving e-mail communication apparatus performs the telephone communication processing designated by the telephone communication designation information in the processing start condition added to the received e-mail and the date and time of the date & time designation information contained in the processing start condition coincide with the current date and time.

11. A method according to claim 1, wherein
in the setting step, action designation information which designates a content of the received mail processing is set together with the processing start condition,
in the sending step, the action designation information is added to e-mail together with the processing start condition, and the e-mail is sent from the sending e-mail communication apparatus to the receiving e-mail communication apparatus, and
in the determining step, processing designated by the action designation information is performed when the e-mail containing the processing start condition is processed.

12. A method according to claim 11, wherein the action designation information designates opening and display as the received mail processing.

13. A method according to claim 11, wherein the action designation information designates voice output as the received mail processing.

14. A method according to claim 11, wherein the action designation information designates forward to a specific forward destination as the received mail processing.

15. A method according to claim 11, wherein the action designation information designates access to a specific resource on Internet as the received mail processing.

16. A method according to claim 1, wherein
the processing start condition includes distance designation information which starts received mail processing when a distance between not less than one specific terminal apparatus and the receiving e-mail communication apparatus is longer or shorter than a predetermined value,
in the monitoring step, the distance between said not less than one specific terminal apparatus and the receiving e-mail communication apparatus is monitored, and
in the determining step, the e-mail containing the processing start condition is processed when the distance between said not less than one specific terminal apparatus and the receiving e-mail communication apparatus satisfies a relationship in magnitude designated by the distance designation information in the processing start condition added to the received e-mail.

17. A method according to claim 1, wherein
in the setting step, processing count designation information which designates a processing count of the received mail is set together with the processing start condition,
in the sending step, the processing count designation information is added to e-mail together with the processing start condition, and the e-mail is sent from the sending e-mail communication apparatus to the receiving e-mail communication apparatus, and
in the determining step, the e-mail containing the processing start condition and the processing count designation information is processed when a log of the processing count of the e-mail is less than a count designated by the processing count designation information.

18. A method according to claim 1, wherein
in the setting step, automatic update designation information which designates whether to automatically update the received mail is set together with the processing start condition,
in the sending step, the automatic update designation information is added to e-mail together with the processing start condition, and the e-mail is sent from the sending e-mail communication apparatus to the receiving e-mail communication apparatus, and
when the receiving e-mail communication apparatus received e-mail containing the automatic update designation information in the past and newly receives e-mail containing the automatic update designation information, the receiving e-mail communication apparatus executes the update step of determining in accordance with the automatic update designation information whether to invalidate the e-mail received in the past and update the e-mail to the newly received e-mail.

19. A method according to claim 18, wherein whether to allow the receiving e-mail communication apparatus to set the automatic update designation information can be selected in setting the automatic update designation information by the sending e-mail communication apparatus.

20. A method according to claim 1, wherein
in the setting step, valid term designation information which designates a valid term of the received mail is set together with the processing start condition,
in the sending step, the valid term designation information is added to e-mail together with the processing start condition, and the e-mail is sent from the sending e-mail communication apparatus to the receiving e-mail communication apparatus, and
in the determining step, the e-mail containing the processing start condition and the valid term designation information is processed within the valid term designated by the valid term designation information.

21. A method according to claim 1, wherein
the processing start condition includes position designation information which starts received mail processing when the receiving e-mail communication apparatus and not less than one specific terminal apparatus reach desired positions,
in the monitoring step, positions of the receiving e-mail communication apparatus and said not less than one specific terminal apparatus are monitored, and
in the determining step, the e-mail containing the processing start condition is processed when the positions of the receiving e-mail communication apparatus and said not less than one specific terminal apparatus coincide with the positions designated by the position designation information in the processing start condition added to the received e-mail.

22. A method according to claim 1, wherein
the processing start condition includes position designation information which starts received mail processing when not less than one specific terminal apparatus reaches a desired position,
in the monitoring step, a position of said not less than one specific terminal apparatus is monitored, and
in the determining step, the e-mail containing the processing start condition is processed when the position designated by the position designation information in the processing start condition added to the received e-mail coincides with the position of said not less than one specific terminal apparatus.

23. An e-mail system comprising a sending e-mail communication apparatus and a receiving e-mail communication apparatus, wherein
said sending e-mail communication apparatus comprises:
setting means for setting a processing start condition representing a condition under which said receiving e-mail communication apparatus starts received mail processing; and
sending means for adding the set processing start condition to e-mail and sending the e-mail, and
said receiving e-mail communication apparatus comprises:
receiving means for receiving the e-mail from said sending e-mail communication apparatus;
monitoring means for monitoring a status of said apparatus or a status of another specific terminal apparatus; and
control means for, when the status of said apparatus or the status of the specific terminal apparatus coincides with the processing start condition added to the received e-mail, processing the e-mail containing the processing start condition.

24. A system according to claim 23, wherein
said monitoring means monitors a status of said apparatus or a status of another specific terminal apparatus, and a current date and time, and
said control means, when the status of said apparatus or the status of the specific terminal apparatus coincides with the processing start condition added to the received e-mail and a date and time of date & time designation information contained in the processing start condition coincide with the current date and time, processes the e-mail containing the processing start condition.

25. A system according to claim 23, wherein
the processing start condition includes position designation information which starts received mail processing when said receiving e-mail communication apparatus reaches a desired position,
said monitoring means of said receiving e-mail communication apparatus monitors a position of said apparatus, and
said control means of said receiving e-mail communication apparatus processes the e-mail containing the processing start condition when the position designated by the position designation information in the processing start condition added to the received e-mail coincides with the position of said apparatus.

26. A system according to claim 23, wherein
the processing start condition includes telephone communication designation information which starts received mail processing when specific telephone communication processing is performed between a terminal apparatus having a specific telephone number and said receiving e-mail communication apparatus,
said the monitoring means of said receiving e-mail communication apparatus monitors telephone communication processing of said apparatus, and
said control means of said receiving e-mail communication apparatus processes the e-mail containing the processing start condition when said apparatus performs the telephone communication processing designated by the telephone communication designation information in the processing start condition added to the received e-mail.

27. A system according to claim 23, wherein
the processing start condition includes mail communication designation information which starts received mail processing when specific mail communication processing is performed between a terminal apparatus having a specific e-mail address and said receiving e-mail communication apparatus,
said monitoring means of said receiving e-mail communication apparatus monitors mail communication processing of said apparatus, and
said control means of said receiving e-mail communication apparatus processes the e-mail containing the processing start condition when said apparatus performs the mail communication processing designated by the mail communication designation information in the processing start condition added to the received e-mail.

28. A system according to claim 23, wherein
the processing start condition includes resource designation information which starts received mail processing when said receiving e-mail communication apparatus accesses a specific resource on Internet,
said monitoring means of said receiving e-mail communication apparatus monitors access to the Internet by said apparatus, and
said control means of said receiving e-mail communication apparatus processes the e-mail containing the processing start condition when said apparatus performs access designated by the resource designation information in the processing start condition added to the received e-mail.

29. A system according to claim 23, wherein
the processing start condition includes communication time designation information which starts received mail processing when a communication time of said receiving e-mail communication apparatus exceeds a predetermined value,
said monitoring means of said receiving e-mail communication apparatus monitors a communication time of said apparatus, and
said control means of said receiving e-mail communication apparatus processes the e-mail containing the processing start condition when the communication time of said apparatus exceeds the predetermined value designated by the communication time designation information in the processing start condition added to the received e-mail.

30. A system according to claim 23, wherein
the processing start condition includes position designation information which starts received mail processing when said receiving e-mail communication apparatus reaches a desired position, and telephone communication designation information which starts received mail processing when specific telephone communication processing is performed between a terminal apparatus having a specific telephone number and said receiving e-mail communication apparatus,
said monitoring means of said receiving e-mail communication apparatus monitors a position of said apparatus and telephone communication processing of said apparatus, and
said control means of said receiving e-mail communication apparatus processes the e-mail containing the processing start condition when the position designated by the position designation information in the processing start condition added to the received e-mail coincides with the position of said apparatus and said apparatus performs the telephone communication processing designated by the telephone communication designation information in the processing start condition.

31. A system according to claim 24, wherein
the processing start condition includes position designation information which starts received mail processing when said receiving e-mail communication apparatus reaches a desired position, and date & time designation information which designates a desired date and time,
said monitoring means of said receiving e-mail communication apparatus monitors a current date and time and a position of said apparatus, and
said control means of said receiving e-mail communication apparatus processes the e-mail containing the processing start condition when the position designated by the position designation information in the processing start condition added to the received e-mail coincides with the position of said apparatus and the date and time of the date & time designation information contained in the processing start condition coincide with the current date and time.

32. A system according to claim 24, wherein
the processing start condition includes telephone communication designation information which starts received mail processing when specific telephone communication processing is performed between a terminal apparatus having a specific telephone number and said receiving e-mail communication apparatus, and date & time designation information which designates a desired date and time,
said monitoring means of said receiving e-mail communication apparatus monitors a current date and time and telephone communication processing of said apparatus, and
said control means of said receiving e-mail communication apparatus processes the e-mail containing the processing start condition when said apparatus performs the telephone communication processing designated by the telephone communication designation information in the processing start condition added to the received e-mail and the date and time of the date & time designation information contained in the processing start condition coincide with the current date and time.

33. A system according to claim 23, wherein
said setting means of said sending e-mail communication apparatus sets, together with the processing start condition, action designation information which designates a content of the received mail processing,
said sending means of said sending e-mail communication apparatus adds the action designation information to e-mail together with the processing start condition, and sends the e-mail from said sending e-mail communication apparatus to said receiving e-mail communication apparatus, and
said control means of said receiving e-mail communication apparatus performs processing designated by the action designation information when processing the e-mail containing the processing start condition.

34. A system according to claim 33, wherein the action designation information designates opening and display as the received mail processing.

35. A system according to claim 33, wherein the action designation information designates voice output as the received mail processing.

36. A system according to claim 33, wherein the action designation information designates forward to a specific forward destination as the received mail processing.

37. A system according to claim 33, wherein the action designation information designates access to a specific resource on Internet as the received mail processing.

38. A system according to claim 23, wherein
the processing start condition includes distance designation information which starts received mail processing when a distance between not less than one specific terminal apparatus and said receiving e-mail communication apparatus is longer or shorter than a predetermined value,
said monitoring means of said receiving e-mail communication apparatus monitors the distance between said not less than one specific terminal apparatus and said receiving e-mail communication apparatus, and
said control means of said receiving e-mail communication apparatus processes the e-mail containing the processing start condition when the distance between said not less than one specific terminal apparatus and said receiving e-mail communication apparatus satisfies a relationship in magnitude designated by the distance designation information in the processing start condition added to the received e-mail.

39. A system according to claim 23, wherein
said setting means of said sending e-mail communication apparatus sets, together with the processing start condition, processing count designation information which designates a processing count of the received mail,
said sending means of said sending e-mail communication apparatus adds the processing count designation information to e-mail together with the processing start condition, and sends the e-mail from said sending e-mail communication apparatus to said receiving e-mail communication apparatus, and
said control means of said receiving e-mail communication apparatus processes the e-mail containing the processing start condition and the processing count designation information when a log of the processing count of the e-mail is less than a count designated by the processing count designation information.

40. A system according to claim 23, wherein
said setting means of said sending e-mail communication apparatus sets, together with the processing start condition, automatic update designation information which designates whether to automatically update the received mail,
said sending means of said sending e-mail communication apparatus adds the automatic update designation information to e-mail together with the processing start condition, and sends the e-mail from said sending e-mail communication apparatus to said receiving e-mail communication apparatus, and
said receiving e-mail communication apparatus further comprises update means for, when e-mail containing the automatic update designation information was received in the past and e-mail containing the automatic update designation information is newly received, determining in accordance with the automatic update designation information whether to invalidate the e-mail received in the past and update the e-mail to the newly received e-mail.

41. A system according to claim 40, wherein whether to allow said receiving e-mail communication apparatus to set the automatic update designation information can be selected in setting the automatic update designation information by said sending e-mail communication apparatus.

42. A system according to claim 23, wherein
said setting means of said sending e-mail communication apparatus sets, together with the processing start condition, valid term designation information which designates a valid term of the received mail,
said sending means of said sending e-mail communication apparatus adds the valid term designation information to e-mail together with the processing start condition, and sends the e-mail from said sending e-mail communication apparatus to said receiving e-mail communication apparatus, and
said control means of said receiving e-mail communication apparatus processes the e-mail containing the processing start condition and the valid term designation information within the valid term designated by the valid term designation information.

43. A system according to claim 23, wherein
the processing start condition includes position designation information which starts received mail processing when said receiving e-mail communication apparatus and not less than one specific terminal apparatus reach desired positions,
said monitoring means of said receiving e-mail communication apparatus monitors positions of said receiving e-mail communication apparatus and said not less than one specific terminal apparatus, and
said control means of said receiving e-mail communication apparatus processes the e-mail containing the processing start condition when the positions of said receiving e-mail communication apparatus and said not less than one specific terminal apparatus coincide with the positions designated by the position designation information in the processing start condition added to the received e-mail.

44. A system according to claim 23, wherein
the processing start condition includes position designation information which starts received mail processing when not less than one specific terminal apparatus reaches a desired position,
said monitoring means of said receiving e-mail communication apparatus monitors a position of said not less than one specific terminal apparatus, and
said control means of said receiving e-mail communication apparatus processes the e-mail containing the processing start condition when the position designated by the position designation information in the processing start condition added to the received e-mail coincides with the position of said not less than one specific terminal apparatus.

45. An e-mail communication apparatus comprising:
receiving means for receiving e-mail sent from a sending e-mail communication apparatus;
monitoring means for monitoring a status of said apparatus or a status of another specific terminal apparatus; and
control means for, when the received e-mail contains a processing start condition representing a condition under which processing of the e-mail starts, and the status of said apparatus or the status of the specific terminal apparatus coincides with the processing start condition, processing the e-mail containing the processing start condition.

46. An apparatus according to claim 45, wherein
said monitoring means monitors a status of said apparatus or a status of another specific terminal apparatus, and a current date and time, and
said control means, when the received e-mail contains a processing start condition representing a condition under which processing of the e-mail starts, the status of said apparatus or the status of the specific terminal apparatus coincides with the processing start condition and a date and time of date & time designation information contained in the processing start condition coincide with the current date and time, processes the e-mail containing the processing start condition.

47. An apparatus according to claim 45, wherein said control means performs processing designated by action designation information added to e-mail together with the processing start condition when processing the e-mail containing the processing start condition.
